(19) United States
(12) Patent Application Publication
(10) Pub. No.: US 2026/0032649 A1
(43) Pub. Date: Jan. 29, 2026

(54) DIVERSITY SCHEME INDICATION

(71) Applicant: QUALCOMM Incorporated, San Diego, CA (US)

(72) Inventors: Kangqi LIU, San Diego, CA (US); Weimin DUAN, San Diego, CA (US); Hyojin LEE, San Diego, CA (US)

(21) Appl. No.: 18/781,025

(22) Filed: Jul. 23, 2024

(51) Int. Cl. H04W 72/0446; H04L 27/26

(52) U.S. Cl. CPC H04W 72/0446; H04L 27/2607

(57) ABSTRACT

Various aspects of the present disclosure generally relate to wireless communication. Various aspects relate more specifically to the indication of a diversity scheme. Some aspects relate to indicating, by a network node and/or a user equipment (UE), whether small delay cyclic delay diversity (SD-CDD) is to be applied to various uplink transmissions to account for the transparency of SD-CDD. In some aspects, the network node may transmit one or more indications to enable and/or disable SD-CDD for some types of uplink communications. In some other aspects, the UE may transmit one or more indications to enable and/or disable SD-CDD for some types of uplink communications. In some aspects, the one or more indications communicated by the network node and/or the UE may define a specific value of the SD-CDD.

### FIELD OF THE DISCLOSURE

Aspects of the present disclosure generally relate to wireless communication and specifically relate to techniques, apparatuses, and methods associated with diversity scheme indication.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IOT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

Some wireless communication systems may support techniques for diversifying characteristics and/or parameters associated with the communication of a message to increase the likelihood that the message is successfully communicated. Such techniques may be referred to as a diversity scheme. In some examples, a diversity scheme may include a transmitting device communicating the message in one or more instances via diversified sets of time domain resources, frequency domain resources, and/or spatial domain resources, among other examples. In such examples, the transmitting device may transmit the message in multiple instances via corresponding (for example, different) sets of time and/or frequency resources in accordance with the diversity scheme. The transmitting device may transmit the message using different ports and/or different antennas.

For example, in a first instance, the transmitting device may transmit the message via a first set of time and/or frequency resources and using a first antenna and/or port (for example, without implementing the diversity scheme). In a second instance, the transmitting device may transmit a version of the message via a second set of time and/or frequency resources and using a second antenna (for example, by applying the diversity scheme). A receiving device may receive the message in both instances and may perform one or more actions to receive and/or process the message independent of the diversity scheme. However, the receiving device may experience a degradation in the performance of the one or more actions because the receiving device may not consider the diversity scheme when performing the one or more actions. As a result, the quality of communications between the transmitting device and the receiving device may be negatively impacted.

### SUMMARY

Some aspects described herein relate to a user equipment (UE) for wireless communication. The UE may include a processing system that includes one or more processors and one or more memories coupled with the one or more processors. The processing system may be configured to cause the UE to communicate an indication that a small delay cyclic delay diversity (SD-CDD) is to be applied. The processing system may be configured to cause the UE to identify, in association with communicating the indication that the SD-CDD is to be applied, a SD-CDD value. The processing system may be configured to cause the UE to transmit multiple instances of a signal in accordance with the SD-CDD value.

Some aspects described herein relate to a network node for wireless communication. The network node may include a processing system including one or more processors and one or more memories and one or more memories coupled with the one or more processors. The processing system may be configured to cause the network node to communicate an indication that a SD-CDD is to be applied. The processing system may be configured to cause the network node to receive, in accordance with communicating the indication that the SD-CDD is to be applied, multiple instances of a signal via a channel, channel estimation information of the channel being in accordance with a SD-CDD value associated with the SD-CDD.

Some aspects described herein relate to a method of wireless communication by a UE. The method may include communicating an indication that a SD-CDD is to be applied. The method may include identifying, in association with communicating the indication that the SD-CDD is to be applied, a SD-CDD value. The method may include transmitting multiple instances of a signal in accordance with the SD-CDD value.

Some aspects described herein relate to a method of wireless communication by a network node. The method may include communicating an indication that a SD-CDD is to be applied. The method may include receiving, in accordance with communicating the indication that the SD-CDD is to be applied, multiple instances of a signal via a channel, channel estimation information of the channel being in accordance with a SD-CDD value associated with the SD-CDD.

Some aspects described herein relate to a non-transitory computer-readable medium that stores a set of instructions for wireless communication by a UE. The set of instructions, when executed by one or more processors of the UE, may cause the UE to communicate an indication that a SD-CDD is to be applied. The set of instructions, when executed by one or more processors of the UE, may cause the UE to identify, in association with communicating the indication that the SD-CDD is to be applied, a SD-CDD value. The set of instructions, when executed by one or more processors of the UE, may cause the UE to transmit multiple instances of a signal in accordance with the SD-CDD value.

Some aspects described herein relate to a non-transitory computer-readable medium that stores a set of instructions for wireless communication by a network node. The set of instructions, when executed by one or more processors of the network node, may cause the network node to communicate an indication that a SD-CDD is to be applied. The set of instructions, when executed by one or more processors of the network node, may cause the network node to receive, in accordance with communicating the indication that the SD-CDD is to be applied, multiple instances of a signal via a channel, channel estimation information of the channel being in accordance with a SD-CDD value associated with the SD-CDD.

Some aspects described herein relate to an apparatus for wireless communication. The apparatus may include means for communicating an indication that a SD-CDD is to be applied. The apparatus may include means for identifying, in association with communicating the indication that the SD-CDD is to be applied, a SD-CDD value. The apparatus may include means for transmitting multiple instances of a signal in accordance with the SD-CDD value.

Some aspects described herein relate to an apparatus for wireless communication. The apparatus may include means for communicating an indication that a SD-CDD is to be applied. The apparatus may include means for receiving, in accordance with communicating the indication that the SD-CDD is to be applied, multiple instances of a signal via a channel, channel estimation information of the channel being in accordance with a SD-CDD value associated with the SD-CDD.

Aspects of the present disclosure may generally be implemented by or as a method, apparatus, system, computer program product, non-transitory computer-readable medium, UE, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of forming a virtual antenna port by combining non-coherent and/or partially-coherent antenna ports in accordance with the present disclosure.

FIG. 5 is a diagram illustrating an example of a diversity scheme based on space frequency block coding (SFBC) in accordance with the present disclosure.

FIG. 6 is a diagram of an example associated with indicating a small delay diversity scheme in accordance with the present disclosure.

FIG. 7 is a diagram illustrating an example associated with semi-persistent small delay cyclic delay diversity (SD-CDD) signaling in accordance with the present disclosure.

FIG. 8 is a diagram illustrating an example associated with SD-CDD signaling in accordance with the present disclosure.

FIG. 9 is a diagram illustrating an example associated with SD-CDD signaling in accordance with the present disclosure.

FIG. 10 is a flowchart illustrating an example process performed, for example, at a UE or an apparatus of a UE that supports a diversity scheme indication in accordance with the present disclosure.

FIG. 11 is a flowchart illustrating an example process performed, for example, at a network node or an apparatus of a network node that supports a diversity scheme indication in accordance with the present disclosure.

FIG. 12 is a diagram of an example apparatus for wireless communication that supports a diversity scheme indication in accordance with the present disclosure.

FIG. 13 is a diagram of an example apparatus for wireless communication that supports a diversity scheme indication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communication systems may support techniques for diversifying characteristics and/or parameters associated with the communication of a message to increase the likelihood that the message is successfully communicated and/or increase a coverage area associated with a wireless communication device. Such techniques may be referred to as a diversity scheme. In some examples, a diversity scheme may include a transmitting device communicating the message in one or more instances via diversified sets of time domain resources, frequency domain resources, and/or spatial domain resources, among other examples. In such examples, the transmitting device may transmit one or more messages in multiple instances via corresponding (for example, different) sets of time and/or frequency resources in accordance with the diversity scheme. The transmitting device may transmit the messages using different antennas and/or different antenna ports.

For example, in a first instance, the transmitting device may transmit messages via a first set of time and/or frequency resources and using a first antenna and/or port (for, example, without implementing the diversity scheme). In a second instance, the transmitting device may transmit a version of the messages via a second set of time and/or frequency resources and using a second antenna (for example, by applying the diversity scheme). A receiving device may receive the messages in both instances and may perform one or more actions based on, or otherwise associated with, the diversity scheme. However, some diversity schemes may be transparent (for example, not indicated) to the receiving device and the receiving device may receive and/or process the messages independently of the diversity scheme. That is, the receiving device may experience a degradation in the performance of the one or more actions because the receiving device may not consider the diversity scheme when performing the one or more actions. As a result, the quality of communications between the transmitting device and the receiving device may be negatively impacted.

As an example, orthogonal frequency division multiplexing (OFDM) systems may use cyclic delay diversity (CDD) as a transmit antenna diversity scheme. The application of CDD may increase the frequency diversity of an effective channel by using different antennas for transmitting respective instances (for example, offset or delayed in the time domain by a CDD value) of a signal to mitigate the effects of at least some instances of inter-symbol interference between instances of the message. The delays may be performed in a cyclic manner to avoid exceeding a guard interval (for example, an interval of time between transmissions that is used to mitigate interference). In some examples, the delays may be a few microseconds and may introduce frequency dependent phase shifts, and/or the durations of the cyclic delays may depend on different bandwidths and/or channel conditions.

For example, channel precoding may be different for different frequency resources of a channel. A type of CDD, sometimes referred to as small delay CDD (SD-CDD), may provide smaller cyclic delays than other types of CDD, such as large delay CDD (LD-CDD). In some examples, for SD-CDD, the delay value may be smaller than a cyclic prefix (CP) length of the transmission. Thus, the effective delay spread (for example, duration between a time of arrival of a firstly received version of the time domain signal and a lastly received version of the time domain signal) after applying SD-CDD may be within a duration of the CP, such that uplink SD-CDD may be performed in a manner that is undetectable by a network node (for example, in a transparent manner). For example, the delay value for LD-CDD and/or typical CDD may be large enough that the use of LD-CDD and/or CDD may affect the ability of a receiving device to receive and/or decode a message applied with LD-CDD and/or CDD if the receiving device does not account for the application of the delay value. For example, the receiving device may receive an indication of the value applied in order to receive and/or decode messages with LD-CDD and/or CDD because the duration of the delay that is applied may be greater than a duration of the CP. Thus, the delay may negatively impact decoding if the value is not indicated to the receiving device.

SD-CDD may be implemented in a transparent manner and/or may be undetected by a network node. As a result, the network node may not have information indicative of whether a user equipment (UE) has applied SD-CDD for each uplink communication. The network node may transmit, and the UE may receive, a control message and/or a scheduling message including an indication of time and/or frequency resources via which the UE may transmit an uplink message. However, if an uplink communication is scheduled using control information and/or scheduling information that does not include precoding information (for example, a transmit precoder matrix indicator (TPMI), a quantity of layers, and/or other precoding information), then the network node may not be enabled to determine whether SD-CDD has been applied to the uplink message scheduled by the corresponding control and/or scheduling information. As opposed to LD-CDD and/or typical CDD, the transmitter may independently apply the SD-CDD delay value and the receiver may successfully receive and/or decode the message without an indication that the SD-CDD is applied (for example, because of the small value of the CDD being applied). While the messages may be communicated successfully, the transparent application of SD-CDD may degrade channel estimation performance because of a difference in obtaining a channel estimation for messages transmitted independently of SD-CDD versus messages applied with SD-CDD.

For example, the network node may receive the uplink communication and perform channel estimation using a power delay profile (PDP) associated with uplink communications. A PDP calculated for channel estimation may include different information depending on whether the network node takes SD-CDD into account when calculating the PDP. The network node may measure a PDP for messages transmitted without SD-CDD and may store the PDP for future channel estimation. The stored PDP may be incongruous with an actual PDP for uplink communications transmitted with SD-CDD. As demodulation reference signal (DMRS) channel estimation considers the PDP for error detection, the misalignment may degrade the channel estimation performance. Thus, the network node may perform channel estimation using information that is not accurate for uplink communications transmitted with SD-CDD. For example, the network node may identify channel conditions that are worse than actual conditions or may identify channel conditions that are better than actual conditions.

Various aspects relate generally to the indication of a diversity scheme. Some aspects more specifically relate to indicating, by a network node and/or by a UE, whether SD-CDD is to be applied to one or more uplink communications. In some aspects, the network node may transmit one or more indications to enable and/or disable SD-CDD for some types of uplink communications (for example, sounding reference signal (SRS) communications, physical uplink shared channel (PUSCH) communications, physical uplink control channel (PUCCH) communications, among other examples). For example, the network node may transmit an indication that the UE is to apply SD-CDD for one or more uplink messages and/or during a given duration of time.

In some other aspects, the UE may transmit one or more indications to enable and/or disable SD-CDD for some types of uplink communications (for example, such as SRS communications, PUSCH communications, PUCCH communications). For example, the UE may indicate to the network node that the UE is to apply SD-CDD for some set of uplink message and/or during some duration of time. In some aspects, the UE may transmit an indication of a value of the SD-CDD to be applied by the UE. In some aspects, the UE may apply SD-CDD to PUSCH communications and/or PUCCH communications and may refrain from applying SD-CDD to SRS communications. Additionally or alternatively, the UE may transmit PUSCH communications and/or PUCCH communications with SD-CDD and may refrain from transmitting SRS.

Particular aspects of the subject matter described in this disclosure can be implemented to realize one or more of the following potential advantages. In some aspects, by the UE and/or the network node indicating whether SD-CDD is to be applied, the described techniques may be used to enhance channel estimation. For example, by the network node and/or UE indicating whether SD-CDD is to be applied, the network node may perform more accurate channel estimation for communications applied with SD-CDD and thus may avoid channel estimation errors associated with the transparency of SD-CDD. Further, when such indications are dynamic and/or flexible (for example, indicate an amount of time during which SD-CDD is to be applied, indicate an activation and/or deactivation of SD-CDD, among other examples) the described techniques may be used to increase coverage via the application of SD-CDD while conserving resources when a diversity scheme is not as applicable or would be less beneficial. Further, the increased accuracy of channel estimation techniques may enhance user experience through increased reliability of service. Some aspects described in this disclosure, such as the indication of an SD-CDD value, may contribute to increased reliability of service for a larger geographical area serviced by a network node through the increased accuracy of channel estimation associated with performing channel estimation using the SD-CDD value, among other examples. For example, by the UE transmitting PUSCH communications and/or PUCCH communications with SD-CDD and refraining from transmitting SRS, the UE may conserve communication resources while increasing channel estimation performance due to the network node performing channel estimation taking SD-CDD into account for messages communicated with SD-CDD thus increasing reliability.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IOT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

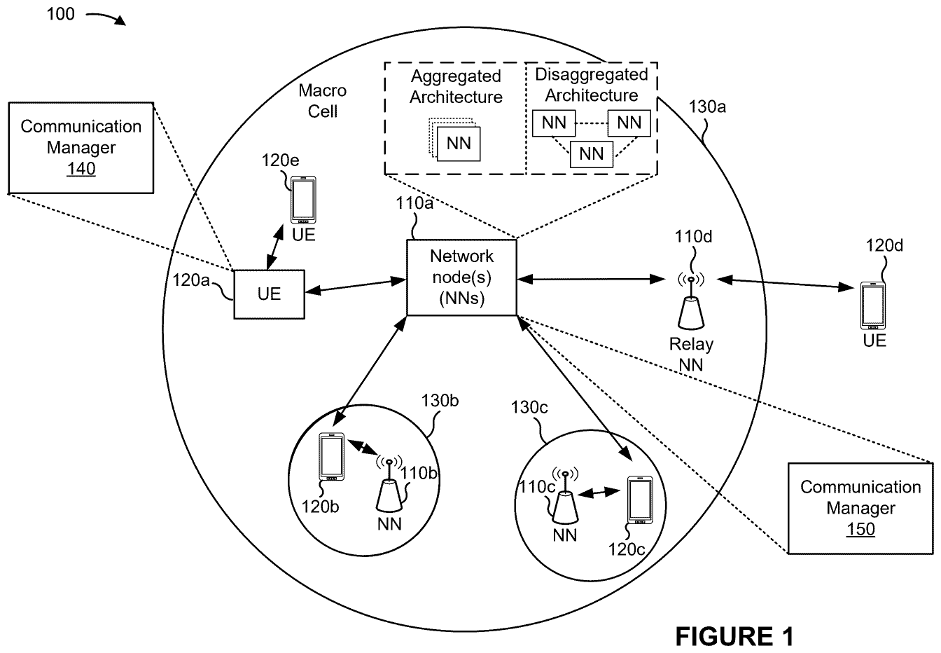

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on, or otherwise associated with, user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, in accordance with a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move in accordance with the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more PUSCHs. The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on, or otherwise associated with, changing network conditions in the wireless communication network 100 and/or based on, or otherwise associated with, the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced cMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IOT (narrowband IoT) devices. An IoT UE or NB-IOT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IOT devices and/or cMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may communicate an indication that a SD-CDD is to be applied; identify, in association with communicating the indication that the SD-CDD is to be applied, a SD-CDD value; and transmit multiple instances of a signal in accordance with the SD-CDD value. Additionally or alternatively, the communication manager 140 may perform one or more other operations described herein.

In some aspects, the network node 110 may include a communication manager 150. As described in more detail elsewhere herein, the communication manager 150 may communicate an indication that a SD-CDD is to be applied; and receive, in accordance with communicating the indication that the SD-CDD is to be applied, multiple instances of a signal via a channel, channel estimation information of the channel being in accordance with a SD-CDD value associated with the SD-CDD. Additionally or alternatively, the communication manager 150 may perform one or more other operations described herein.

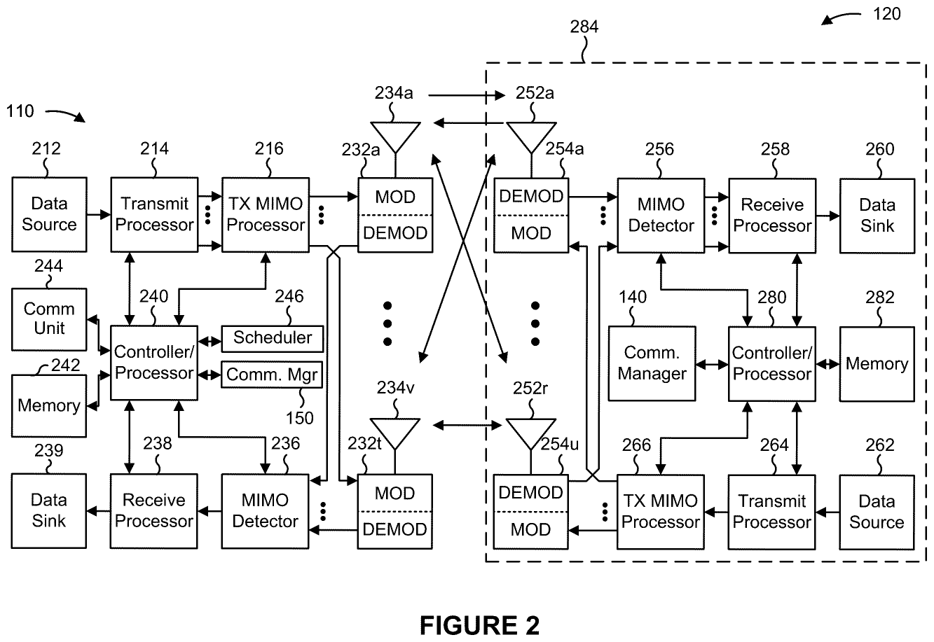

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a DMRS, or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for OFDM) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on, or otherwise associated with, or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include an reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for discrete Fourier transform (DFT)-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different quantities of antenna elements. For example, a UE 120 may include a single antenna element, two antenna elements, four antenna elements, eight antenna elements, or a different quantity of antenna elements. As another example, a network node 110 may include eight antenna elements, 24 antenna elements, 64 antenna elements, 128 antenna elements, or a different quantity of antenna elements. Generally, a larger quantity of antenna elements may provide increased control over parameters for beam generation relative to a smaller quantity of antenna elements, whereas a smaller quantity of antenna elements may be less complex to implement and may use less power than a larger quantity of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

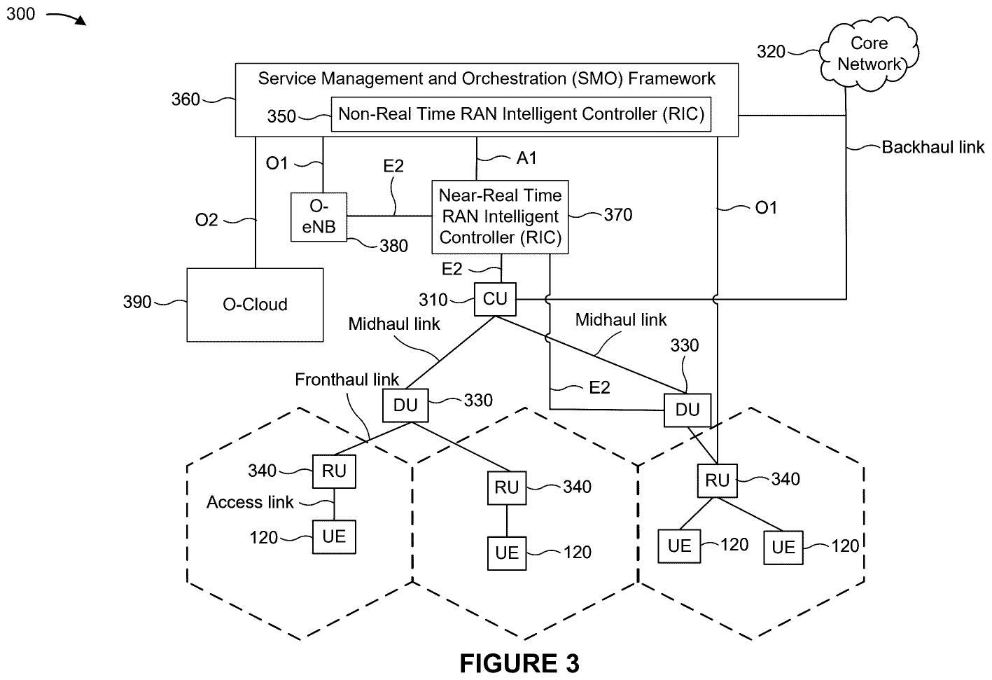

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

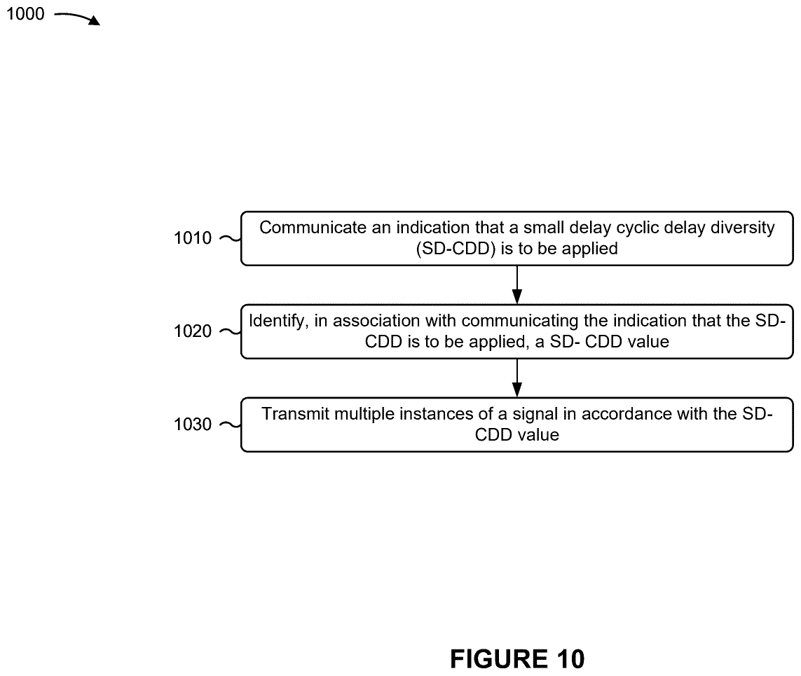

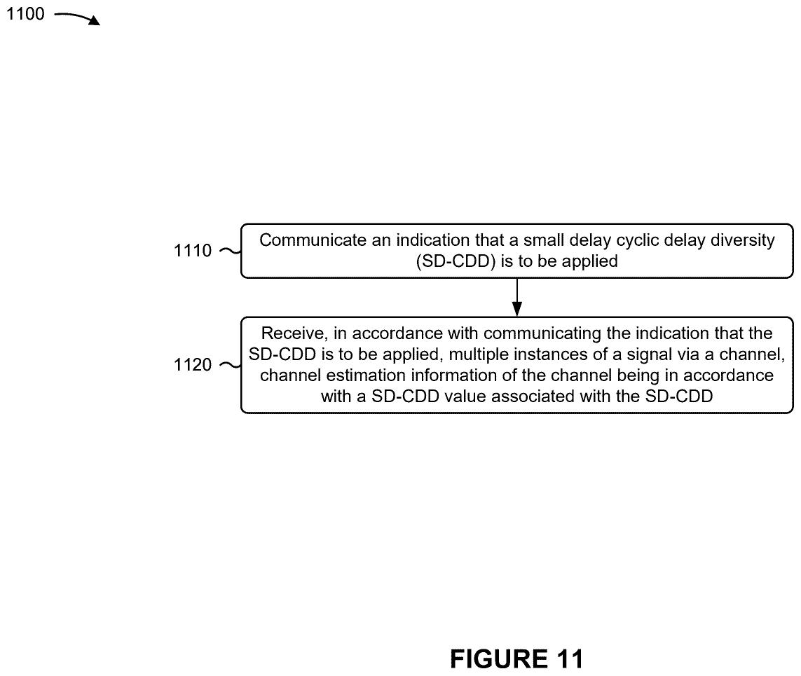

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with diversity scheme indication, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for communicating an indication that a SD-CDD is to be applied; means for identifying, in association with communicating the indication that the SD-CDD is to be applied, a SD-CDD value; and/or means for transmitting multiple instances of a signal in accordance with the SD-CDD value. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for communicating an indication that a SD-CDD is to be applied; and/or means for receiving, in accordance with communicating the indication that the SD-CDD is to be applied, multiple instances of a signal via a channel, channel estimation information of the channel being in accordance with a SD-CDD value associated with the SD-CDD. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

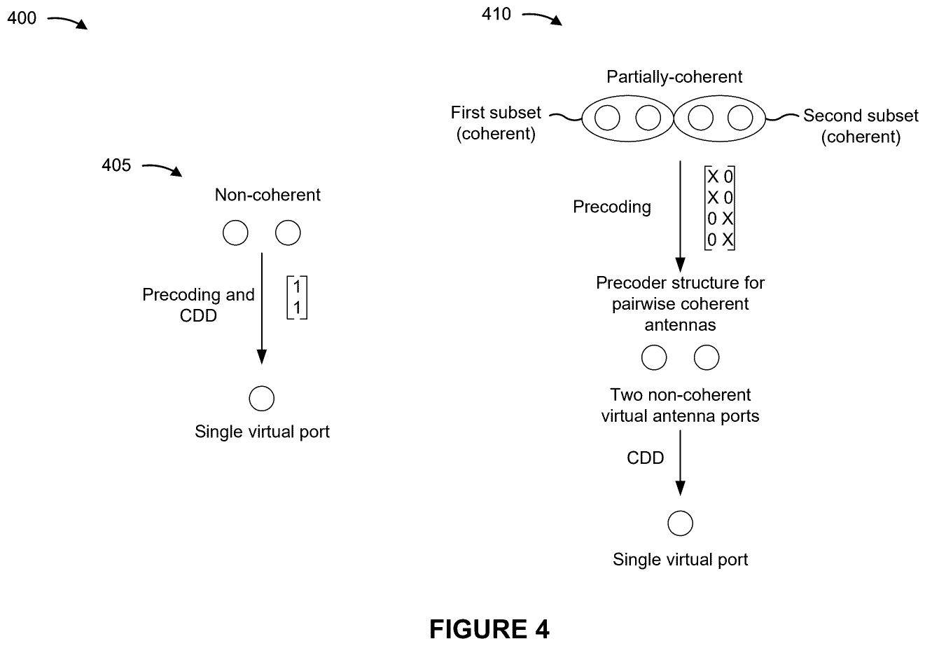

FIG. 4 is a diagram illustrating examples of forming a virtual antenna port 405 and 410 by combining non-coherent and/or partially-coherent antenna ports in accordance with the present disclosure.

The antennas of a multi-antenna wireless communication device, such as a UE (for example, UE 120), may be classified into one of three groups depending on coherence of the antenna ports of the UE. A set of antenna ports (for example, two antenna ports) are coherent if the relative phase among the set of antenna ports (for example, between the two antenna ports) remains the same between the time of an SRS transmission from those antenna ports and a subsequent PUSCH transmission from those antenna ports. In such examples, the SRS may be used (for example, by the UE or a network node) to determine an uplink precoder for precoding the PUSCH transmission, because the relative phase of the antenna ports will be the same for the SRS transmission and the PUSCH transmission. The precoding may span across the set of coherent antenna ports.

If a set of antenna ports is non-coherent, then such uplink precoder determination becomes difficult, because the relative phase between the antenna ports will change from the SRS transmission to the PUSCH transmission. For example, a set of antenna ports is considered non-coherent if the relative phase among the set of antenna ports is different for the SRS transmission than for the PUSCH transmission. In such examples, the use of the same uplink precoder for a set of non-coherent antenna ports may result in the UE applying improper or inaccurate precoding weights (such as phase and gain weights) to the data streams transmitted from the non-coherent antenna ports. Furthermore, a set of antenna ports is considered partially-coherent if a first subset of the set of antenna ports is coherent with one another and a second subset of the set of antenna ports is coherent with one another, but the first subset of antenna ports and the second subset of antenna ports are not coherent with one another. In such examples, common precoding may be used within each of the respective subsets of coherent antenna ports, but not across the different subsets of non-coherent antenna ports.

In some examples, when a network node schedules a PUSCH transmission for a multi-antenna UE having non-coherent or partially-coherent antenna ports, the signaling communication that schedules the PUSCH transmission may identify an uplink precoder that is to be used to precode the PUSCH transmission. Conventionally, because the antenna ports of the UE are non-coherent (or, in the case of partially coherent antenna ports, are non-coherent groups of coherent antenna ports), the UE may be capable of using the uplink precoder for only one of the antenna ports (or antenna port groups) while other antenna ports (or antenna port groups) are not used for the PUSCH transmission. Because only a subset of non-coherent or partially coherent antenna ports are used, this may result in decreased transmit power of the PUSCH transmission, decreased reliability of the PUSCH transmission (due to lack of transmit or spatial diversity), or the like.

To utilize some or all of the non-coherent or partially coherent antenna ports, the UE may apply various techniques to synthesize non-coherent or partially coherent antenna ports into a virtual antenna port so that common precoding may be used on the virtual antenna port and applied across the non-coherent antenna ports. A virtual (or logical) antenna port may represent a combination of two or more antenna ports. This allows a network node to select an uplink precoder for the virtual antenna port, and allows the UE to use the uplink precoder to transmit on the otherwise non-coherent or partially coherent antenna ports that have been combined to form the virtual antenna port.

As shown in example 405 of FIG. 4, a set of non-coherent antenna ports (for example, shown as two non-coherent antenna ports) can be combined into a single virtual port using precoding (for example, uplink precoding) and cyclic delay diversity. The precoder may be determined by the UE and/or signaled by a network node. CDD may refer to a technique where a delay (for example, a cyclic delay) is introduced on one of the non-coherent antenna ports and not the other non-coherent antenna port(s). In some examples, the delay may be measured in samples (for example, 5 samples, 10 samples, or another quantity of samples) or fractions of samples. For example, a first non-coherent antenna port may transmit a first stream of samples, and the second non-coherent antenna port may transmit a second stream of samples (for example, which may be the same stream) with a slight cyclic delay (for example, a delay of 5 samples, 10 samples, or another quantity of samples). As used herein, an “instance” of a signal refers to a stream of samples that is transmitted via a given antenna port or antenna element. A UE may transmit multiple instances of a signal by applying CDD. The multiple instances may be the same (in such examples, a instance may be referred to as a “copy” of a signal) or may be different (for example, a first instance may include a first subset of samples and a second instance may include a second subset of samples). For example, for a cyclic delay of 5 samples, where 16 samples are transmitted per symbol (for example, where the 16 samples are an instance or copy of a signal), the first non-coherent antenna port may transmit the 16 samples with a first sample transmitted first (for example, [s1, s2, s3, s4, . . . , s16]), and the second non-coherent antenna port may transmit the 16 samples with the first sample transmitted sixth (for example, with a delay of five samples) (for example, [s12, s13, s14, s15, s16, s1, s2, s3, . . . , s11]).

SD-CDD is a type of CDD in which the cyclic delay that is introduced on a subset of the non-coherent antenna ports has a smaller value (for example, duration and/or quantity of samples) than a length of the CP and/or has a value that is small enough not to cause a delay spread that is longer than the length of the CP.

Additionally or alternatively, as shown in example 410 of FIG. 4, a set of partially-coherent antenna ports can be combined into a single virtual antenna port using precoding (for example, uplink precoding) and cyclic delay diversity, in a similar manner as described above. As shown, a first subset of antenna ports may be coherent with one another, and a second subset of antenna ports may be coherent with one another, but the two subsets may not be coherent with one another. As further shown, precoding may be applied to the individual subsets to generate a first virtual antenna port and a second virtual antenna port that are not coherent with one another. Then, SD-CDD and/or CDD may be applied to these two virtual antenna ports (for example, by transmitting communications from the virtual antenna ports using SD-CDD and/or CDD), thereby forming a single virtual antenna port from the partially-coherent antenna ports (for example, using precoding and SD-CDD and/or CDD).

A network node may receive the communications from the virtual antenna ports but the delay spread of the communications and/or the delay in each version of the communications may be undetectable by the network node. If unaccounted for, SD-CDD may cause inaccurate channel estimation to be performed by the network node thusly degrading the quality of communications between the UE and the network node.

Although FIG. 4 shows pairs of antenna ports in sets and subsets, in some examples, a different quantity of antenna ports may be included in a set or a subset. For example, a set of antenna ports or subset of antenna ports may include three antenna ports, four antenna ports, or another quantity of antenna ports.

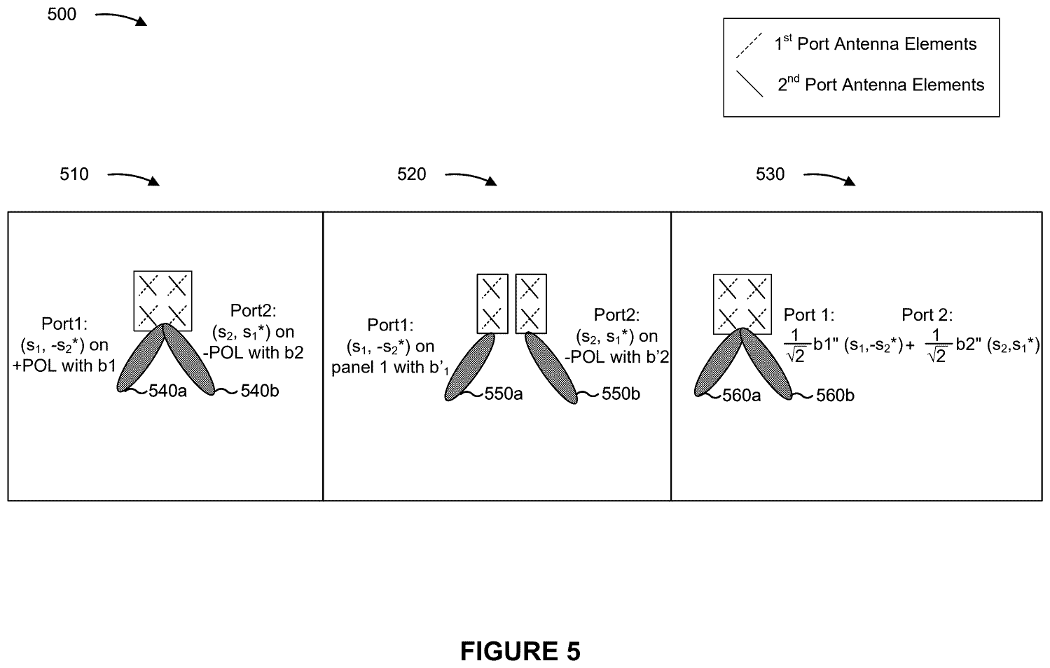

FIG. 5 is a diagram illustrating an example of a diversity scheme 500 based on space frequency block coding (SFBC) in accordance with the present disclosure.

A UE (for example, UE 120) may implement a diversity scheme for 2-port MIMO communications in which DMRS are transmitted from both ports used for the 2-port MIMO communications. In some examples, the diversity scheme for 2-port MIMO communication may be based on, or otherwise associated with, SFBC. In such examples, the UE may apply a different polarization to each port (for example, antenna, panel configuration, and/or antenna array configuration) to transmit a data stream, s which may include a first symbol s₁ and a second symbol s₂.

In a first antenna configuration 510, a first port and/or antenna applied with a first polarization may transmit the first symbol s₁ of the data stream during a first time-frequency resource and may transmit the negative conjugate of s2 (for example, −s₂*) during a second time-frequency resource. A second port and/or antenna applied with a second polarization may transmit the second symbol s₂ of the data stream during the first time-frequency resource and may transmit the conjugate of s₁ (for example, s₁*) during the second time-frequency resource. That is, the first antenna configuration 510 may be an example of two-port MIMO as applied to two transmit antennas and/or ports, where the first port and/or antenna transmits (s₁, −s₂*) using a first communication beam 540a (b₁) and the second port and/or antenna may transmit (s₂, s₁*) using a second communication beam 540b (b₂).

In a second antenna configuration 520, a first sub-array of antennas may transmit the first symbol s₁ of the data stream during a first time-frequency resource and may transmit the negative conjugate of s₂, −s₂*, during a second time-frequency resource. A second sub-array of antennas may transmit the second symbol s₂ of the data stream during the first time-frequency resource and may transmit the conjugate of s₁, s₁*, during the second time-frequency resource. That is, the second antenna configuration 520 may be an example of two-port MIMO as applied to a panel of transmit antennas, where the first sub-array acting as a first port may transmit (s₁, −s₂*) using a first communication beam 550a (b′₁) and the second sub-array acting as a second port may transmit (s₂, s₁*) using a second communication beam 550b.

$$( {b}_{2}^{′} ) .$$

In a third antenna configuration 530, an array of antennas may transmit the first symbol s of the data stream during a first time-frequency resource and may transmit the negative conjugate of s₂, −s₂*, during a second time-frequency resource via a first communication beam 560a

$$( {b}_{1}^{″} ) .$$

The array of antennas may transmit the second symbol s₂ of the data stream during the first time-frequency resource and may transmit the conjugate of s₁, s₁*, during the second time-frequency resource via a second communication beam 560b

$$( {b}_{2}^{″} ) .$$

That is, the third antenna configuration 530 may be an example of two-port MIMO as applied to a panel of transmit antennas, where the array, acting as a first port, may transmit a signal

$$\frac{1}{\sqrt{2}} {b}_{1}^{″} ( {s}_{1} , - {s}_{2}^{*} )$$

using the first communication beam 560a

$$( {b}_{2}^{″} )$$

and the array, acting as a second port, may transmit a signal,

$$\frac{1}{\sqrt{2}} {b}_{2}^{″} ( {s}_{2} , - {s}_{1}^{*} )$$

using the second communication beam 560b

$$( {b}_{1}^{″} ) .$$

Some wireless communication standards (for example, 5G communication standards, NR communication standards) may not support SFBC. For example, some wireless communications standards may not support SFBC because SFBC is performed using at least two antenna ports to transmit a single layer, however multi-layer spatial multiplexing may provide techniques for achieving a high spectral efficiency. Further, multiple transmissions schemes and inconsistencies between the data signal and DMRS transmission may complicate UE implementation complexity and may limit the application of interference-aware advanced receivers.

Thus, CDD may be applied as part of SFBC communications (for example, via an OFDM transmitter). For example, a transmitter may apply OFDM modulation to a signal s to obtain a signal 9(k) which may then be used to obtain a signal per antenna in accordance with Equation 1, below:

$${s}_{i} ( k ) = \frac{1}{\sqrt{{N}_{T}}} ( \tilde{s} - {δ}_{i} ) , i = 0 , … , {N}_{T} - 1 \qquad [ 1 ]$$

As used in Equation 1, sᵢ(k) may refer to the signal as a function of subcarrier, N_{T} may refer to a quantity of antennas for transmitting the signal, \tilde{s}(k) may refer to the signal after OFDM modulation, and δᵢ may refer to a cyclic delay. Thus, a first instance of the signal, s₀(k) may be transmitted via a first antenna, a second instance of the signal, s₁(k) may be transmitted via a second antenna with a delay,

$${δ}_{1}^{cyc} ,$$

and an N_{T}^{th} instance of the signal, s_{N}_{_{T}}₋₁(k) may be transmitted via an N_{T}^{th} antenna with a delay,

$${δ}_{{N}_{T} - 1}^{cyc} .$$

Thus, OFDM systems may use CDD as a transmit antenna diversity scheme. The application of CDD may increase the frequency diversity of an effective channel by using different antennas for simultaneously transmitting delayed versions of the time domain signal to avoid at least some instances of inter-symbol interference between instances of the message. The delays may be performed in a cyclic manner to avoid exceeding a guard interval (for example, an interval of time between transmissions that is used to prevent interference). In some examples, the delays may be a few microseconds and may introduce frequency dependent phase shifts and/or the durations of the cyclic delays may depend on different bandwidths and/or channel conditions.

For example, channel precoding may be different for different frequency resources of a channel. SD-CDD may provide smaller cyclic delays than CDD and/or LD-CDD. In some examples, the delay value may be chosen to be smaller than a CP length of the transmission. Thus, the effective delay spread (for example, duration between a time of arrival of a firstly received version of the time domain signal and a lastly received version of the time domain signal) after applying SD-CDD may be within a duration of the CP such that uplink SD-CDD may be performed in a manner that is undetectable by a network node (for example, in a transparent manner).

For example, in a transparent example, channel estimation may be performed independently from a delay spread estimation (for example, may be performed without current delay spread estimation and/or information) to remain transparent.

A transmitter applying CDD may obtain one or more signals for transmission. The transmitter may identify a quantity of FFT symbols, N_{FFT} and may identify a quantity of modulated symbols, S(l), for each subcarrier, where l=1, . . . , N_{FFT}−1. The transmitter may apply an inverse FFT, may apply the cyclic delay, and may append a CP to each signal such that:

$${s}_{i} ( k ) = \frac{1}{\sqrt{{N}_{T}}} ( \tilde{s} - {δ}_{i}^{cyc} mod ( {N}_{FFT} ) ) ,$$

$$i = 0 , … , {N}_{T} - 1 ;$$

$$k = - {N}_{G} , … , {N}_{F F T} - 1$$

where, sᵢ(k) may refer to the signal at a time domain sample k and from an antenna i, N_{T} may refer to a quantity of antennas for transmitting the signal, \tilde{s} may refer to the signal after OFDM modulation

$${δ}_{i}^{cyc}$$

may refer to the cyclic delay, i may refer to an antenna index, and k may refer to a time domain sample index. In some examples, a maximum delay after applying may equal

$$[ ( {δ}_{max}^{cyc} + {N}_{max} ) mod {N}_{FFT} ] \times {τ}_{s} ,$$

where

$${δ}_{max}^{cyc} = {max}_{i} {δ}_{i}^{cyc} ,$$

Nₘₐₓ may refer to the maximum channel delay in terms of samples, and τₛ may be the sampling rate.

A receiver may receive the CDD signals and may perform CP removal via FFT using the equation below to obtain the signal.

$$R ( l ) = [ \frac{1}{\sqrt{{N}_{T}}} {\sum }_{i = 0}^{{N}_{T} - 1} {e}^{- j \frac{2 π}{{N}_{FFT}} {δ}_{i}^{{cyc}_{l}}} {H}_{i} ( l ) ] S ( l ) + N ( l )$$

where,

$${\sum }_{i = 0}^{{N}_{T} - 1} {e}^{- j \frac{2 π}{{N}_{FFT}} {δ}_{i}^{{cyc}_{l}}} {H}_{i} ( l )$$

may be an effective channel H(l), R(l) may refer to the received signal, j may refer to an imaginary number (for example, the square root of negative 1), and Hᵢ(l) may refer to the channel between the i^{th} transmit antenna and a receive antenna (for example, where l is the subcarrier index in the frequency domain).

In an example, a 30 KHz subcarrier spacing, where the CP length may be 288 samples may be 288×1/(30000-4096) s, which may equal 2.34 μs. For SD-CDD, a cyclic delay may be:

$${δ}_{max}^{cyc} < CP length - {N}_{max} .$$

In some samples, the delay spread (or, for example, the maximum delay), which may include the channel delay and/or the cyclic delay, may be transparently measured by the receiver.

Channel estimation may be performed based on, or otherwise associated with, the delay spread (or, for example, the max delay) measured transparently by the receiver, and demodulation may be performed based on, or otherwise associated with, measuring the delay spread. However, for transparent SD-CDD, a suboptimal channel estimation may be applied due to the transparent nature of the application of SD-CDD by a transmitter, such as a UE.

For example, a root mean square delay may be measured as 300 ns. The receiver may apply a minimum mean square error (MMSE) channel estimation based on, or otherwise associated with, frequency domain correlation assuming the uniform delay profile with maximum 2×300 ns, regardless of SD-CDD. For a more accurate delay estimation, the transmitted may account for SD-CDD. If some reference signals (for, example such as tracking reference signals) are transmitted independently of SD-CDD, a delay may still be applied but, an

$$δ {m}_{max}^{cyc}$$

value may be a “very small” value, which may limit transmission diversity gain. For example, “very small” may refer to delay values that are transparent to the receiver and/or have minimal impact on channel estimation techniques, decoding, and/or signal structure, among other examples. In the uplink transmission, the transmitter may apply the SD-CDD for potential diversity gain, especially for the single-port case. The transmitter may use multiple antennas for the single port SD-CDD transmission. The receiver may detect or receive a transmission via a single port although the transmitter communicated using multiple antennas.

However, because SD-CDD may be implemented in a transparent manner and/or may be undetected by the receiver, the receiver may not have information indicative of whether the transmitter has applied SD-CDD for each uplink transmission. For example, a network node may transmit, and a UE may receive a control message and/or a scheduling message including an indication of time and/or frequency resources via which the UE may transmit an uplink communication. But, if an uplink transmission is scheduled using control information and/or scheduling information that does not include precoding information (for example, such as some formats of DCI, including at least DCI 0_0), the network node may not be enabled to determine whether SD-CDD has been applied to the uplink communication scheduled by the corresponding control and/or scheduling information.

The network node may receive the uplink transmission and perform channel estimation using a PDP associated with uplink communications. For example, the UE may transmit, and the network node may receive, a set of DMRSs via the uplink communications. The network node may perform channel estimation based on, or otherwise associated with, the DMRSs received in the uplink communications and/or may calculate a PDP based on, or otherwise associated with, the received uplink communications.

A PDP calculated for channel estimation may include different information depending on whether the network node takes SD-CDD into account. That is, the network node may measure a PDP for uplink communications (for example, SRS communications, PUSCH communications, and/or PUCCH communications) transmitted without SD-CDD and may store the PDP for future channel estimation. The stored PDP may be incongruous with an actual PDP for uplink communications (for example, SRS communications, PUSCH communications, and/or PUCCH communications) transmitted with SD-CDD. As the DMRS channel estimation takes the PDP into account for error detection (for example, MMSE detection), the misalignment may degrade the channel estimation performance. Thus, the network node may perform channel estimation using information that is not accurate for uplink communications transmitted with SD-CDD. For example, the network node may identify channel conditions that are worse than actual conditions or may identify channel conditions that are better than actual conditions.

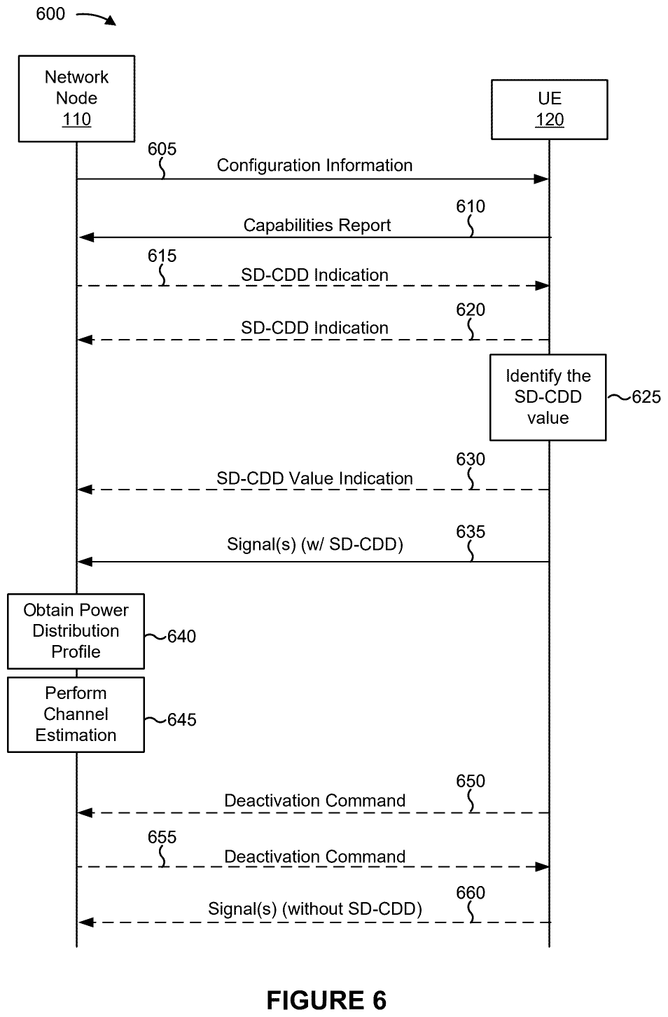

FIG. 6 is a diagram of an example associated with indicating a small delay diversity scheme 600 in accordance with the present disclosure. As shown in FIG. 6, a network node 110 (for example, network node, a CU, a DU, and/or an RU) may communicate with a UE 120. In some aspects, the network node 110 and the UE 120 may be part of a wireless communication network (for example, wireless communication network 100). The UE 120 and the network node 110 may have established a wireless connection prior to operations shown in FIG. 6.

FIG. 6 may illustrate signaling and/or operations that support schemes for indicating SD-CDD for uplink communication. An efficient diversity scheme may increase diversity for broadcast data and/or control channels, may provide increased diversity for communications before an RRC connection is established, and/or may provide a fallback channel estimation technique in situations with unreliable CSI feedback (for example, high speed situations). For example, FIG. 6 may demonstrate aspects of the communication of commands that may enable and/or disable SD-CDD for various types of uplink communications (for example, SRS communications, PUSCH communications, and/or PUCCH communications) and/or the communication of indications between the UE 120 and the network node 110 including an explicit value of SD-CDD via MAC-CE and/or other control signaling.

In a first operation 605, the network node 110 may transmit, and the UE 120 may receive, configuration information. In some aspects, the UE 120 may receive the configuration information via one or more of system information (for example, a master information block (MIB) and/or a system information block (SIB), among other examples), RRC signaling, MAC signaling (for example, one or more MAC control elements (MAC-CEs)), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (for example, an indication described herein) may include a dynamic indication, such as one or more MAC-CEs and/or one or more DCI messages, among other examples.

In some aspects, the configuration information may indicate that the UE 120 is to enable or activate one or more operations associated with SD-CDD. For example, the UE 120 may receive the configuration information and perform one or more operations and/or enable one or more settings to prepare for applying SD-CDD to enable the one or more operations associated with SD-CDD. In some aspects, the UE 120 may receive the configuration information and apply SD-CDD to at least one message as part of activating the one or more operations associated with SD-CDD.

The UE 120 may configure itself based on, or otherwise associated with, the configuration information. In some aspects, the UE 120 may be configured to perform one or more operations described herein based on, or otherwise associated with, the configuration information.

In a second operation 610, the UE 120 may transmit, and the network node 110 may receive, a capabilities report. The capabilities report may indicate whether the UE 120 supports a feature and/or one or more parameters related to the feature. For example, the capabilities report may indicate a capability and/or parameter for diversity scheme application and/or indication. As another example, the capabilities report may indicate a capability and/or parameter for applying and/or indicating a specific value for SD-CDD. One or more operations described herein may be based on, or otherwise associated with, capability information of the capabilities report. For example, the UE 120 may perform a communication in accordance with the capability information, or may receive configuration information that is in accordance with the capability information. In some aspects, the capabilities report may indicate UE support for SD-CDD communications. In some aspects, the capabilities report may indicate UE support for transmitting an indication that SD-CDD is to be applied. In some aspects, the capabilities report may indicate UE support for receiving an indication that SD-CDD is to be applied. In some aspects, the capabilities report may indicate UE support for applying SD-CDD to a subset of uplink message types (for example, where types may include SRS messages, PUSCH messages, PUCCH messages, among other examples).

In some aspects, the network node 110 may transmit, and the UE 120 may receive, control signaling including a configuration for the one or more SRSs, where the configuration may indicate that a usage of the one or more SRSs is associated with the SD-CDD. In some examples, the control signaling may be received in connection with the configuration information described as part of the first operation 605.

In some aspects, the configuration information described in connection with the first operation 605 and/or the capabilities report described in connection with the second operation 610 may include information transmitted via multiple communications. Additionally or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

In some aspects, the UE 120 and the network node 110 may communicate an indication that an SD-CDD is to be applied. In some aspects, communicating the indication that the SD-CDD is to be applied may include, in a third operation 615, the network node 110 transmitting, and the UE 120 receiving an SD-CDD indication. For example, the network node 110 may transmit, and the UE 120 may receive, the indication that the SD-CDD is to be applied by the UE 120.

In some aspects, the UE 120 may receive the indication that the SD-CDD is to be applied by receiving control signaling including the indication. For example, the network node 110 may transmit, and the UE 120 may receive, control signaling including the indication that the SD-CDD is to be applied. In some aspects, the network node 110 may transmit, and the UE 120 may receive a DCI message, a MAC-CE message, an RRC message, and/or one or more SPS communications, among other examples. For example, the DCI message, the MAC-CE message, the RRC message, and/or the one or more SPS communications may include the indication that the SD-CDD is to be applied. In some aspects, the DCI message, including the indication that the SD-CDD is to be applied, may include a grant associated with communicating one or more signals (for example, in accordance with the SD-CDD).

In some other aspects, communicating the indication that the SD-CDD is to be applied may include, in a fourth operation 620, the UE 120 transmitting, and the network node 110 receiving, an SD-CDD indication. For example, the UE 120 may transmit, and the network node 110 may receive, the indication that the SD-CDD is to be applied.

In some aspects, the UE 120 may transmit the indication that the SD-CDD is to be applied by transmitting control signaling including the indication. For example, the UE 120 may transmit, and the network node 110 may receive, control signaling including the indication that the SD-CDD is to be applied. In some aspects, the UE 120 may transmit, and the network node 110 may receive, a control information message (for example, a UCI message), and/or a MAC-CE message, among other examples. For example, the control information message and/or the MAC-CE message may include the indication that the SD-CDD is to be applied.

In some aspects, as part of the third operation 615 and/or the fourth operation 620, communicating the indication that the SD-CDD is to be applied may include communicating a first communication including an activation command associated with applying the SD-CDD. For example, the indication that the SD-CDD is to be applied may include the activation command. In some aspects, the activation command may be valid until a deactivation command is communicated.

In some aspects, as part of the third operation 615 and/or the fourth operation 620, communicating the indication that the SD-CDD is to be applied may include communicating a first communication including the indication that the SD-CDD is to be applied, where the indication is associated with a timer indicative of a time period during which the SD-CDD is to be applied.

In a fifth operation 625, the UE 120 may identify an SD-CDD value. For example, the UE 120, in association with communicating the indication that the SD-CDD is to be applied (as described in connection with the third operation 615 and/or the fourth operation 620), may identify a SD-CDD value. In some aspects, the UE 120 may identify the SD-CDD value based on, or otherwise associated with, a length of a cyclic prefix associated with the one or more signals to be transmitted. In some aspects, the UE 120 may identify any SD-CDD value that is less than (CP length−Nₘₐₓ), where Nₘₐₓ is a quantity of available antennas for the transmission. In some aspects, the UE 120 may identify the SD-CDD value based on, or otherwise associated with, one or more channels conditions, one or more parameters of the message(s) to be transmitted, one or more parameters of an antenna array of the UE 120, among other examples.

In a sixth operation 630, in some examples, the UE 120 may transmit, and the network node 110 may receive, the SD-CDD value indication. For example, in addition to or instead of the SD-CDD indication described as part of the fourth operation 620, the UE 120 may transmit, and the network node 110 may receive, an explicit indication of the SD-CDD value. In some aspects, the indication that the SD-CDD is to be applied may include the indication of the SD-CDD value. In some aspects, the indication of the SD-CDD value is included in a MAC-CE and/or other control signaling.

In a seventh operation 635, the UE 120 may transmit, and the network node 110 may receive, one or more signals in accordance with the SD-CDD value. For example, the UE 120 may transmit one or more signals in accordance with the SD-CDD value (for example, the SD-CDD value identified as part of the fifth operation 625 and/or the SD-CDD value transmitted as part of the sixth operation 630). In some aspects, the one or more signals may include one or more SRSs, one or more uplink control channel signals, and/or one or more uplink data channel signals. In some aspects, the one or more signals may include two or more types of signals, and the SD-CDD value may be one of multiple SD-CDD values for respective types of signals of the two or more types of signals. For example, the UE 120 may transmit multiple copies or instances of a given signal. The UE 120 may apply the SD-CDD value to offset (for example, in time) the multiple copies or instances of the given signal. For example, transmitting one or more signals in accordance with the SD-CDD value may refer to transmitting multiple copies or instances of a given signal that are offset (for example, in time) by the SD-CDD value.

In some aspects, the SD-CDD values for the respective types of signals are a same SD-CDD value. For example, the network node 110 may apply a single SD-CDD to a set of different messages when performing channel estimations. The UE 120 may conserve processing resources by applying a single SD-CDD value to a set of different messages and/or indicating a single SD-CDD value.

In some aspects, the SD-CDD values include a first SD-CDD value for a first type of signal and a second SD-CDD value for a second type of signal, and the first SD-CDD value may be different than the second SD-CDD value. For example, coverage for some types of messages may be extended through diversity gain while resources are conserved for other message by refraining from applying, indicating, or performing channel estimation on messages applied with SD-CDD.

In some aspects, transmitting the one or more signals may include transmitting a PUSCH message and/or a PUCCH message independently of one or more SRSs. For example, the UE 120 may transmit, and the network node 110 may receive, a PUSCH message and/or a PUCCH message independently of one or more SRSs. For example, the UE 120 may conserve resources by refraining from transmitting an SRS message when channel estimation has already been performed for SD-CDD messages and non-SD-CDD messages and/or when channel estimation may be skipped or is not necessary. In some aspects, transmitting the one or more signals may include transmitting one or more SRSs in accordance with the SD-CDD value. For example, the UE 120 may transmit, and the network node 110 may receive, one or more SRSs in accordance with the SD-CDD value.

In some examples, as part of the seventh operation 635, the network node 110 may receive one or more signals via a channel. In such aspects, the network node 110 may obtain channel estimation information of the channel in accordance with a SD-CDD value associated with the SD-CDD. For example, the network node 110 may perform channel estimation of the channel based on, or otherwise associated with, the SD-CDD value.

For example, the UE 120 may be configured with one or more SRS resource sets to allocate resources for SRS transmissions by the UE 120. For example, a configuration for SRS resource sets may be indicated in an RRC message (for example, an RRC configuration message or an RRC reconfiguration message). An SRS resource set may include one or more resources (for example, SRS resources), which may include time resources and/or frequency resources (for example, a slot, a symbol, a resource block, and/or a periodicity for the time resources). An SRS resource may include one or more antenna ports on which an SRS is to be transmitted (for example, in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (for example, in an SRS-SetUse information element) for the SRS resource set. For example, the use case (for example, a usage) for the SRS resource set may be associated with SD-CDD. The UE 120 may identify that SD-CDD is to be applied based on, in response to, or otherwise associated with being configured with an SRS resource set having a configured use case or usage that is associated with SD-CDD. For example, the indication that SD-CDD is to be applied (for example, transmitted by the network node 110 in the third operation 615) may include a transmission of an SRS resource set configuration where the SRS resource set has a configured use case or usage that is associated with SD-CDD.

In an eighth operation 640, the network node 110 may obtain a PDP. For example, the network node 110 may obtain channel estimation information (for example, a PDP) associated with the one or more reference signals.

A PDP may indicate a power level of a channel across different instances of time. In other words, the PDP may indicate an averaged power level over a period of time. The PDP may filter out instant fluctuations in power levels of the channel. One or more reference signals may be used to obtain the PDP.

In some aspects, the network node 110 may obtain the PDP for communications to which SD-CDD has been applied (for example, an SD-CDD PDP) using one or more reference signals (for example, by measuring one or more reference signals, such as SRS). For example, the network node 110 may measure one or more reference signals (for example, an SRS, a DMRS, or another reference signal) to which SD-CDD has been applied. Additionally or alternatively, the network node 110 may obtain the PDP for communications independent of SD-CDD using one or more reference signals (for example, by measuring one or more reference signals, such as SRS). For example, the network node 110 may measure one or more reference signals transmitted independently of SD-CDD (for example, reference signals to which SD-CDD has not been applied).

In a ninth operation 645, the network node 110 may perform channel estimation. For example, the network node 110 may perform, using the PDP obtained in the eighth operation 640, a channel estimation operation to obtain the channel estimation information. In some aspects, a channel impulse response may be estimated using the PDP (for example, the PDP obtained using one or more reference signals). The network node 110 may calculate one or more channel coefficients based on, or otherwise associated with, the channel impulse response estimated from the PDP.

In a tenth operation 650, in some aspects, the UE 120 may transmit, and the network node 110 may receive, a deactivation command. In other aspects, in an eleventh operation 655, the network node 110 may transmit, and the UE 120 may receive a deactivation command.

In some aspects, the UE 120 and/or the network node 110 may communicate, after communicating the first communication (for example, including the activation command), a second communication including a deactivation command that indicates that the SD-CDD is not to be applied. In some aspects, the deactivation command may be valid (for example, SD-CDD is not to be applied) until a subsequent activation command is communicated.

In a twelfth operation 660, in some aspects, the UE 120 may transmit, and the network node 110 may receive, one or more signals independent of the SD-CDD value. For example, the UE 120, and/or the network node 110 may communicate, in accordance with an expiry of the timer, one or more other signals independent of the SD-CDD value. In some such aspects, the UE 120 may apply SD-CDD to transmissions communicated while the timer is running and may cease applying SD-CDD to transmission communicated after the timer expires (for example, ends or is no longer active and/or running). As a result, the UE 120 and/or the network node 110 may identify that SD-CDD is not longer to be applied based on, or otherwise associated with, the timer expiring (for example, in instances where the time (for applying SD-CDD) is initiated when the SD-CDD timer indication is initially communicated).

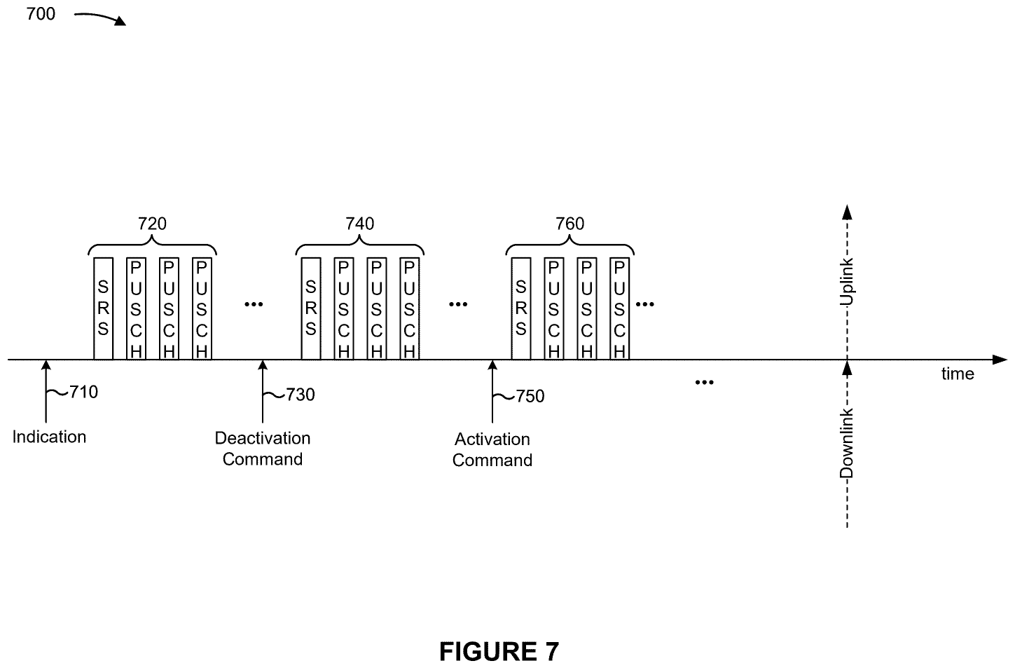

FIG. 7 is a diagram illustrating an example associated with semi-persistent SD-CDD signaling 700 in accordance with the present disclosure. FIG. 7 illustrates communications (for example, between a network node 110 (for example, network node 110 as described herein) and a UE 120 (for example, UE 120 as described herein)). In some aspects, the communications may occur in a wireless network, such as wireless communication network 100. The communicates may occur via a wireless access link, which may include an uplink and a downlink.

As shown in FIG. 7, the network node 110 may transmit, and the UE 120 may receive, an indication to apply SD-CDD for subsequent uplink communications. For example, the network node 110 may transmit, and the UE 120 may receive, an indication 710. In some aspects, the indication 710 may be communicated via control signaling including a control message (for example, a dynamic control message configured to be communicated more than once with updateable fields and/or indications), such as DCI, and/or MAC-CE, among other examples. In some other aspects, the indication 710 may be communicated via control signaling, such as RRC signaling, among other examples. The indication 710 may indicate that the UE 120 is to apply SD-CDD to subsequent messages, such as SRS, PUSCH, and/or PUCCH transmissions, among other examples.

In some aspects, the indication 710 may indicate to the UE 120 that the UE 120 is to enable SD-CDD for subsequent communications and/or may include an activation command for SD-CDD. For example, in some aspects, the indication 710 may indicate that SD-CDD is enabled (available to be activated) but SD-CDD may not be activated at the UE 120 (for example, indicated that the UE 120 is to apply SD-CDD for subsequent communications) until an activation command is received. In some other aspects, the indication 710 may indicate that SD-CDD is enabled and may activate SD-CDD at the UE 120. In yet some other aspects, the indication 710 may indicate that SD-CDD is enabled which may additionally activate SD-CDD at the UE 120.

Additionally or alternatively, the indication 710 may indicate that the SD-CDD value to be applied by the UE 120 to different types of messages is the same. For example, an SD-CDD value applied to a first message type may be the same as the SD-CDD value applied to a second message type based on, or otherwise associated with, the indication 710 indicating that the SD-CDD value to be applied is the same. In some aspects, the UE 120 may apply the same SD-CDD value for different types of messages without the indication 710 indicating that the SD-CDD value to be applied is the same (for example, a default behavior may include applying a same SD-CDD value to different transmission types). In other aspects, the indication 710 may additionally or alternatively indicate that the SD-CDD value to be applied to different types of messages is different. In some aspects, the UE may apply a different SD-CDD values to different types of messages without an indication to do so being included in the indication 710.

The UE 120 may apply the SD-CDD to a first set of messages 720 and/or the UE 120 may transmit the first set of messages 720 in accordance with the SD-CDD (for example, based on, or otherwise associated with, receiving the indication 710). The network node 110 may schedule the first set of messages 720 via a first control message, such as DCI, which may include a grant of resources for communicating the first set of messages 720. In some aspects, the first control message may additionally include the indication 710. In some aspects, the first set of messages 720 may include SRS message(s), PUSCH message(s), and/or PUCCH message(s), among other examples. In some aspects, SD-CDD may be activated until the network node 110 communicates subsequent instructions and/or a subsequent command.

For example, the network node 110 may transmit, and the UE 120 may receive, an indication to deactivate SD-CDD for subsequent uplink communications. That is, the network node 110 may transmit, and, the UE 120 may receive, a deactivation command 730. In some aspects, the deactivation command 730 may be communicated via control signaling including a control message (for example, a dynamic control message configured to be communicated more than once with updateable fields and/or indications), such as DCI, and/or MAC-CE, among other examples. In some other aspects, the deactivation command 730 may be communicated via control signaling, such as RRC signaling, among other examples. The deactivation command 730 may indicate that the UE 120 is to communicate subsequent messages without applying SD-CDD.

For example, the UE 120 may transmit a second set of messages 740 independent of the SD-CDD (for example, based on, or otherwise associated with, receiving the deactivation command 730). The network node 110 may schedule the second set of messages 740 via the first control message or via a second control message (for example, a second DCI message) which may include a grant of resources for communicating the second set of messages 740. In some aspects, the first control message and/or the second control message may additionally include the deactivation command 730. In some aspects, the second set of messages 740 may include SRS message(s), PUSCH message(s), and/or PUCCH message(s), among other examples. In some aspects, SD-CDD may be deactivated until the network node 110 communicates subsequent instructions and/or a subsequent command.

For example, the network node 110 may transmit, and the UE 120 may receive, an indication to activate SD-CDD for subsequent uplink communications. That is, the network node 100 may transmit, and the UE 120 may receive, an activation command 750. In some aspects, the activation command 750 may be communicated via control signaling including a control message (for example, a dynamic control message configured to be communicated more than once with updateable fields and/or indications), such as DCI, and/or MAC-CE, among other examples. In some other aspects, the activation command 750 may be communicated via control signaling, such as RRC signaling, among other examples. The activation command 750 may indicate that the UE 120 is to apply SD-CDD for subsequent messages.

For example, the UE 120 may apply the SD-CDD to a third set of messages 760 and/or the UE 120 may transmit the third set of messages 760 in accordance with the SD-CDD (for example, based on, or otherwise associated with, receiving the activation command 750). The network node 110 may schedule the third set of messages 760 via the first control message, the second control message, and/or or via a third control message (for example, a third DCI message) which may include a grant of resources for communicating the third set of messages 760. In some aspects, the first control message, the second control message, and/or the third control message may additionally include the activation command 750. In some aspects, the third set of messages 760 may include SRS, PUSCH, and/or PUCCH, among other examples. In some aspects, SD-CDD may be activated until the network node 110 communicates subsequent instructions and/or a subsequent command. That is, the SD-CDD may remain activated until a second deactivation command is communicated.

In some aspects, the network node 110 may obtain a PDP for communications to which SD-CDD has been applied (for example, an SD-CDD PDP) via an SRS communication (for example, the SRS of the first set of messages 720 and/or the SRS of the third set of messages 760). Additionally or alternatively, the network node 110 may obtain a PDP for communications independent of SD-CDD via an SRS communication (for example, the SRS of the second set of messages 740). The network node 110 may use the SD-CDD PDP and/or the PDP for channel estimation.

In some aspects, any of the indication 710, the deactivation command 730, and/or the activation command 750 may include a semi-persistent indication and/or be included in semi-persistent signaling.

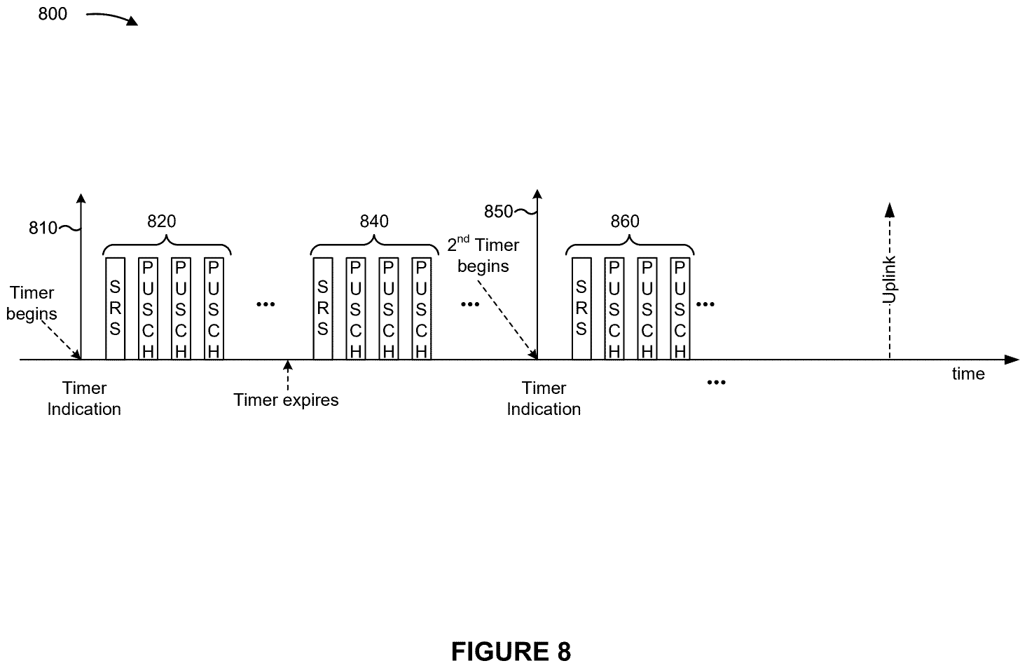

FIG. 8 is a diagram illustrating an example associated with SD-CDD signaling 800 in accordance with the present disclosure. FIG. 8 illustrates communications (for example, between a network node 110 (for example, network node 110 as described herein) and a UE 120 (for example, UE 120 as described herein)). In some aspects, the communications may occur in a wireless network, such as wireless communication network 100. The communicates may occur via a wireless access link, which may include an uplink and a downlink.

As shown in FIG. 8, the UE 120 may transmit, and the network node 110 may receive, an indication of a timer and/or a duration during which the UE 120 is to apply SD-CDD for subsequent uplink communications. For example, the UE 120 may transmit, and the network node 110 may receive, a timer indication 810 indicative of a timer and/or a duration during which the UE 120 is to apply SD-CDD. In some aspects, the timer indication 810 may be communicated via control signaling including an indication (for example, configured to be communicated more than once with updateable fields and/or indications), such as UCI, DCI, and/or MAC-CE, among other examples. The timer indication 810 may indicate that the UE 120 is to apply SD-CDD to one or more messages, such as SRS messages, PUSCH messages, and/or PUCCH messages, among other examples, that are communicated during the indicated duration and/or while the indicated timer is active (for example, has been initiated, is counting down time, and/or is running).

In some aspects, the timer indication 810 may indicate that the UE 120 will be activating or applying SD-CDD (for example, may activate any procedures and/or processing associated with transmitting messages to which SD-CDD will be applied and/or applying SD-CDD) for subsequent messages communicated during the indicated duration and/or while the indicated timer is active.

Additionally or alternatively, the timer indication 810 may indicate that the UE 120 is to apply the same SD-CDD value to different types of messages. For example, an SD-CDD value applied to a first message type may be the same as the SD-CDD value applied to a second message type based on, or otherwise associated with, the indication 810 indicating that the SD-CDD value to be applied is the same. In other aspects, the timer indication 810 may indicate that the UE 120 is to apply different SD-CDD values to different types of messages. In some examples, the timer indication 810 may indicate the timer and/or duration independent of an SD-CDD value. In some aspects, the UE 120 may activate (for example, begin and/or initiate) the timer by transmitting the timer indication 810. In some other aspects, the UE 120 may identify a beginning of the duration associated with the timer by transmitting the timer indication 810.

The UE 120 may apply the SD-CDD to a first set of messages 820 and/or the UE 120 may transmit the first set of messages 820, in accordance with the SD-CDD (for example, based on, or otherwise associated with, transmitting the timer indication 810), communicated while the timer is active (for example, after the timer indication 810 is transmitted). In some aspects, the first set of messages 820 may include SRS, PUSCH, and/or PUCCH, among other examples. In some aspects, the UE 120 may apply SD-CDD to one or more transmissions (for example, SD-CDD may be activated) until the timer expires and/or the duration ends (the timer and/or duration indication by timer indication 810). In some aspects, the SD-CDD may remain inactive until the timer is restarted and/or the UE 120 transmits another timer indication that triggers the beginning of the duration and/or the activation of the timer.

For example, the timer may expire and/or the duration may end which may indicate to the network node 110 and/or the UE 120 that the UE 120 is to communicate subsequent messages without applying SD-CDD (for example, until the timer is restarted and/or the UE 120 transmits another timer indication that triggers the beginning of the duration and/or the activation of the timer).

For example, the UE 120 may transmit a second set of messages 840 independent of the SD-CDD (for example, based on, or otherwise associated with, the timer expiring and/or the duration ending). In some aspects, the second set of messages 840 may include SRS messages, PUSCH messages, and/or PUCCH messages, among other examples. In some aspects, SD-CDD may be deactivated until the UE 120 communicates a second timer indication and/or the timer is restarted.

For example, the UE 120 may transmit, and the network node 110 may receive, an additional indication of a timer and/or a duration during which the UE 120 is to apply SD-CDD for subsequent uplink communications. The network node 110 may transmit, and the UE 120 may receive, a timer indication 850. In some aspects, the timer indication 850 may be communicated via control signaling including a control message (for example, a dynamic control message configured to be communicated more than once with updateable fields and/or indications), such as UCI, DCI, and/or MAC-CE, among other examples. The timer indication 850 may indicate that the UE 120 is to apply SD-CDD to one or more messages, such as SRS messages, PUSCH messages, and/or PUCCH messages, among other examples, that are communicated during the indicated duration and/or while the indicated timer is active.

For example, the UE 120 may apply the SD-CDD to a third set of messages 860 and/or the UE 120 may transmit the third set of messages 860 in accordance with the SD-CDD (for example, based on, or otherwise associated with, transmitting the timer indication 850). In some aspects, the third set of messages 860 may include SRS messages, PUSCH messages, and/or PUCCH messages, among other examples. In some aspects, SD-CDD may be activated until the timer expires and/or the duration ends (the timer and/or duration indication by timer indication 850). In some aspects, the SD-CDD may remain inactive until the timer is restarted and/or the UE 120 transmits another timer indication that triggers the beginning of the duration and/or the activation of the timer. In some aspects, the timer and/or duration indicated by the timer indication 810 is the same as the timer and/or duration indicated by the timer indication 850. In some other aspects, the timer and/or duration indicated by the timer indication 810 is different from the timer and/or duration indicated by the timer indication 850.

In some aspects, the network node 110 may obtain a PDP for communications to which SD-CDD has been applied (for example, an SD-CDD PDP) via an SRS communication (for example, the SRS of the first set of messages 820 and/or the SRS of the third set of messages 860). Additionally or alternatively, the network node 110 may obtain a PDP for communications independent of SD-CDD via an SRS communication (for example, the SRS of the second set of messages 840). The network node 110 may use the SD-CDD PDP and/or the PDP for channel estimation.

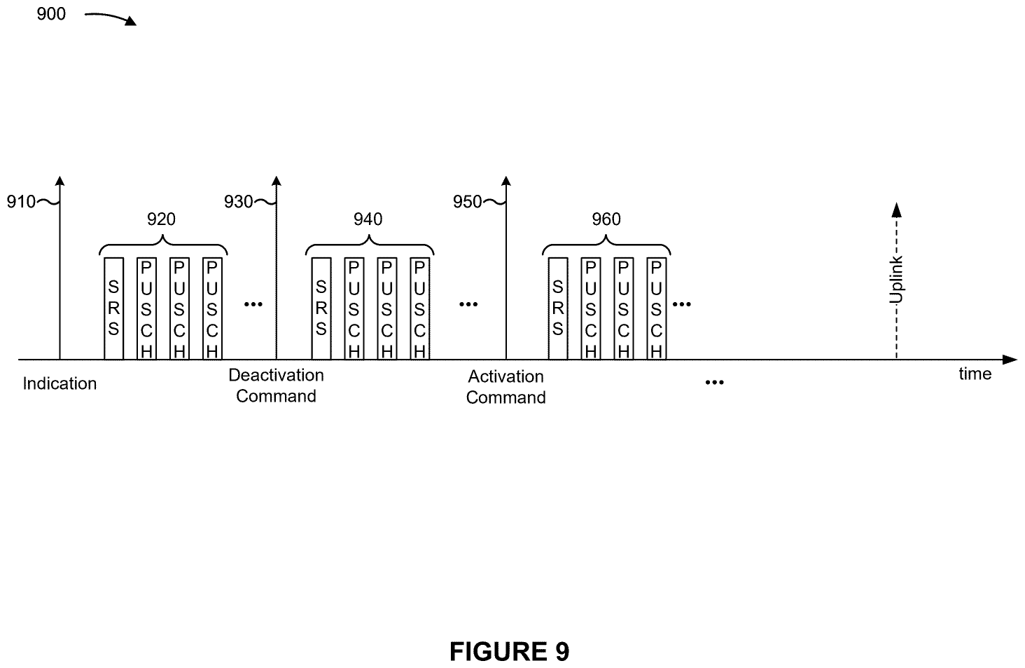

FIG. 9 is a diagram illustrating an example associated with SD-CDD signaling 900 in accordance with the present disclosure. FIG. 9 illustrates communications (for example, between a network node 110 (for example, network node 110 as described herein) and a UE 120 (for example, UE 120 as described herein)). In some aspects, the communications may occur in a wireless network, such as wireless communication network 100. The communicates may occur via a wireless access link, which may include an uplink and a downlink.

As shown in FIG. 9, the UE 120 may transmit, and the network node 110 may receive, an indication that the UE is to apply SD-CDD for subsequent uplink communications. For example, the UE 120 may transmit, and the network node 110 may receive, an indication 910. In some aspects, the indication 910 may be communicated via control signaling including a control message (for example, a dynamic control message configured to be communicated more than once with updateable fields and/or indications), such as UCI, DCI, and/or MAC-CE, among other examples. The indication 910 may indicate that the UE 120 is to apply SD-CDD to subsequent messages, such as SRS, PUSCH, and/or PUCCH transmissions, among other examples.

In some aspects, the indication 910 may indicate that the UE 120 is enabling or applying SD-CDD for subsequent communications and/or may include an activation command for SD-CDD (for example, may activate any procedures and/or processing associated with receiving messages to which SD-CDD has been applied) at the network node 110. For example, in some aspects, the indication 910 may indicate that SD-CDD is enabled (available to be activated) but SD-CDD may not be activated at the UE 120 and/or the network node 110 until an explicit activation command is communicated. In some other aspects, the indication 910 may indicate that SD-CDD is enabled and may activate SD-CDD at the network node 110 and/or the UE 120. In some other aspects, the indication 910 may indicate that SD-CDD is enabled which may additionally activate SD-CDD at the UE 120 and/or the network node 110.

The indication 910 may additionally or alternatively indicate that the SD-CDD value to be applied by the UE 120 to different types of messages is the same. For example, an SD-CDD value applied to a first message type may be the same as the SD-CDD value applied to a second message type based on, or otherwise associated with, the indication 710 indicating that the SD-CDD value to be applied is the same. In other aspects, the indication 910 may additionally or alternatively indicate that the SD-CDD to be applied to different types of messages is different.

The UE 120 may apply the SD-CDD to a first set of messages 920 and/or the UE 120 may transmit the first set of messages 920 in accordance with the SD-CDD (for example, based on, or otherwise associated with, transmitting the indication 910). In some aspects, the first set of messages 920 may include SRS messages, PUSCH messages, and/or PUCCH messages, among other examples. In some aspects, SD-CDD may be activated until the UE 120 communicates subsequent instructions and/or a subsequent command.

For example, the UE 120 may transmit, and the network node 110 may receive, an indication to deactivate SD-CDD for subsequent uplink communications. The UE 120 may transmit, and the network node 110 may receive, a deactivation command 930. In some aspects, the deactivation command 930 may be communicated via a control signaling including a control message (for example, a dynamic control message configured to be communicated more than once with updateable fields and/or indications), such as UCI, DCI, and/or MAC-CE, among other examples. The deactivation command 930 may indicate that the UE 120 is to communicate subsequent messages without applying SD-CDD.

For example, the UE 120 may transmit a second set of messages 940 independent of the SD-CDD (for example, based on, or otherwise associated with, transmitting the deactivation command 930). In some aspects, the second set of messages 940 may include SRS messages, PUSCH messages, and/or PUCCH messages, among other examples. In some aspects, SD-CDD may be deactivated until the UE 120 communicates subsequent instructions and/or a subsequent command.

For example, the UE 120 may transit, and the network node 110 may receive, an indication to activate SD-CDD for subsequent uplink communications. That is, the UE 120 may transmit, and the network node 110 may receive, an activation command 950. In some aspects, the activation command 950 may be communicated via control signaling including a control message (for example, a dynamic control message configured to be communicated more than once with updateable fields and/or indications), such as UCI, DCI, and/or MAC-CE, among other examples. The activation command 750 may indicate that the UE 120 is to apply SD-CDD for subsequent messages.

For example, the UE 120 may apply the SD-CDD to a third set of messages 960 and/or the UE 120 may transmit the third set of messages 960 in accordance with the SD-CDD (for example, based on, or otherwise associated with, transmitting the activation command 950). In some aspects, the third set of messages 960 may include SRS communications, PUSCH communications, and/or PUCCH communications, among other examples. In some aspects, SD-CDD may be activated until the UE 120 communicates subsequent instructions and/or a subsequent command. That is, the SD-CDD may remain activated until a second deactivation command is communicated.

In some aspects, the network node 110 may obtain a PDP for communications to which SD-CDD has been applied (for example, an SD-CDD PDP) via an SRS communication (for example, the SRS of the first set of messages 920 and/or the SRS of the third set of messages 960). Additionally or alternatively, the network node 110 may obtain a PDP for communications independent of SD-CDD via an SRS communication (for example, the SRS of the second set of messages 940). The network node 110 may use the SD-CDD PDP and/or the PDP for channel estimation.

In any of the examples described herein (for example, with regard to FIGS. 6-8), the UE may additionally or alternatively indicate (for example, to the network node) an explicit value of the SD-CDD applied to uplink communications. In some aspects, a MAC-CE may include the indication of the explicit value of the SD-CDD.

In some aspects, the SD-CDD applied to SRS messages may be different from an SD-CDD applied to PUSCH and/or PUCCH messages. In some other aspects, the SD-CDD applied to SRS messages may the same as an SD-CDD applied to PUSCH and/or PUCCH messages. In some aspects, the UE may apply SD-CDD to PUSCH transmissions and/or PUCCH transmissions and may transmit SRS messages independently from the SD-CDD. In some other aspects, the UE may apply SD-CDD to SRS transmissions and may transmit PUSCH communications and/or PUCCH communications independently from the SD-CDD. In some other aspects, the UE may refrain from transmitting SRS when transmitting PUSCH communications and/or PUCCH communications.

In some aspects, a wireless telecommunication standard (for example, 5G communication standards, NR communication standards) may define a type of SRS messages for SD-CDD. For example, some SD-CDD SRS messages may be allocated to or assigned to communicating an RRC configuration.

FIG. 10 is a flowchart illustrating an example process 1000 performed, for example, at a UE or an apparatus of a UE that supports a diversity scheme indication in accordance with the present disclosure. Example process 1000 is an example where the apparatus or the UE (for example, UE 120) performs operations associated with diversity scheme indication.

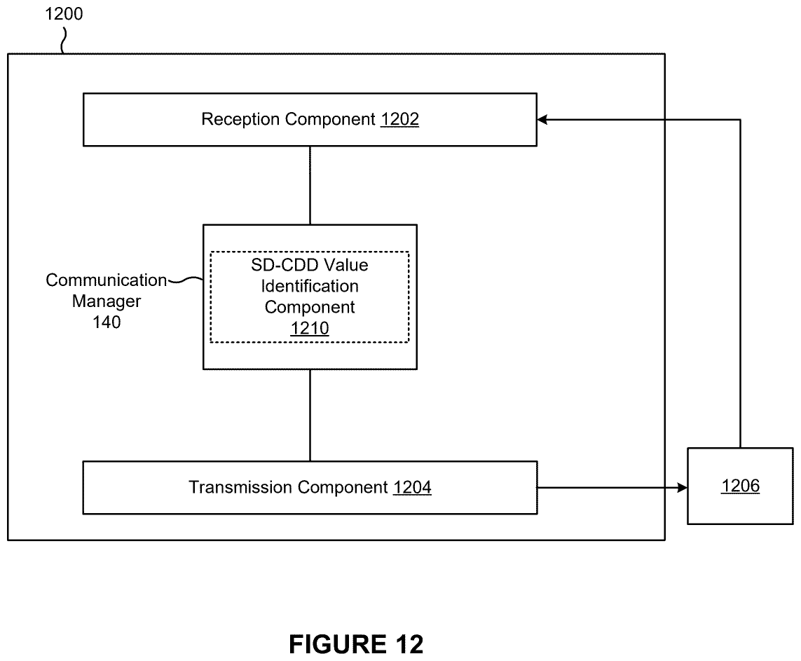

As shown in FIG. 10, in some aspects, process 1000 may include communicating an indication that a SD-CDD is to be applied (block 1010). For example, the UE (such as by using communication manager 140, reception component 1202, or transmission component 1204, depicted in FIG. 12) may communicate an indication that a SD-CDD is to be applied, as described above.

As further shown in FIG. 10, in some aspects, process 1000 may include identifying, in association with communicating the indication that the SD-CDD is to be applied, a SD-CDD value (block 1020). For example, the UE (such as by using communication manager 140 or SD-CDD value identification component 1210, depicted in FIG. 12) may identify, in association with communicating the indication that the SD-CDD is to be applied, a SD-CDD value, as described above.

As further shown in FIG. 10, in some aspects, process 1000 may include transmitting multiple instances of a signal in accordance with the SD-CDD value (block 1030). For example, the UE (such as by using communication manager 140 or transmission component 1204, depicted in FIG. 12) may transmit multiple instances of a signal in accordance with the SD-CDD value, as described above.

Process 1000 may include additional aspects, such as any single aspect or any combination of aspects described below or in connection with one or more other processes described elsewhere herein.

In a first additional aspect, communicating the indication that the SD-CDD is to be applied includes receiving, from a network node, the indication that the SD-CDD is to be applied by the UE.

In a second additional aspect, alone or in combination with the first aspect, receiving the indication that the SD-CDD is to be applied includes receiving control signaling including the indication.

In a third additional aspect, alone or in combination with one or more of the first and second aspects, receiving the indication that the SD-CDD is to be applied includes receiving at least one of a downlink control information message, a MAC-CE message, or an RRC message.

In a fourth additional aspect, alone or in combination with one or more of the first through third aspects, receiving the indication that the SD-CDD is to be applied includes receiving a downlink control information message including a grant associated with the signal, wherein the downlink control information message includes the indication that the SD-CDD is to be applied.

In a fifth additional aspect, alone or in combination with one or more of the first through fourth aspects, communicating the indication that the SD-CDD is to be applied includes communicating a first communication including the indication that the SD-CDD is to be applied, wherein the indication includes an activation command associated with applying the SD-CDD, and process 1000 includes communicating, after communicating the first communication, a second communication including a deactivation command that indicates that the SD-CDD is not to be applied.

In a sixth additional aspect, alone or in combination with one or more of the first through fifth aspects, the activation command is valid until the deactivation command is communicated.

In a seventh additional aspect, alone or in combination with one or more of the first through sixth aspects, the deactivation command is valid until a subsequent activation command is communicated.

In an eighth additional aspect, alone or in combination with one or more of the first through seventh aspects, communicating the indication that the SD-CDD is to be applied is included in one or more SPS communications.

In a ninth additional aspect, alone or in combination with one or more of the first through eighth aspects, communicating the indication that the SD-CDD is to be applied includes transmitting the indication that the SD-CDD is to be applied.

In a tenth additional aspect, alone or in combination with one or more of the first through ninth aspects, transmitting the indication that the SD-CDD is to be applied includes transmitting control signaling including the indication that the SD-CDD is to be applied.

In an eleventh additional aspect, alone or in combination with one or more of the first through tenth aspects, transmitting the indication that the SD-CDD is to be applied includes transmitting at least one of a control information message, or a MAC-CE message.

In a twelfth additional aspect, alone or in combination with one or more of the first through eleventh aspects, communicating the indication that the SD-CDD is to be applied includes communicating a first communication including the indication that the SD-CDD is to be applied, wherein the indication is associated with a timer indicative of a time period during which the SD-CDD is to be applied, and process 1000 includes communicating, in accordance with an expiry of the timer, one or more other signals independent of the SD-CDD value.

In a thirteenth additional aspect, alone or in combination with one or more of the first through twelfth aspects, process 1000 includes transmitting an indication of the SD-CDD value.

In a fourteenth additional aspect, alone or in combination with one or more of the first through thirteenth aspects, the indication that the SD-CDD is to be applied includes the indication of the SD-CDD value.

In a fifteenth additional aspect, alone or in combination with one or more of the first through fourteenth aspects, the indication of the SD-CDD value is included in a MAC-CE.

In a sixteenth additional aspect, alone or in combination with one or more of the first through fifteenth aspects, transmitting the multiple instances of the signal includes transmitting the multiple instances of the signal independently of one or more SRSs.

In a seventeenth additional aspect, alone or in combination with one or more of the first through sixteenth aspects, transmitting the multiple instances of the signal includes transmitting multiple copies of an SRS in accordance with the SD-CDD value.

In an eighteenth additional aspect, alone or in combination with one or more of the first through seventeenth aspects, process 1000 includes receiving control signaling including a configuration for the one or more SRSs, wherein the configuration indicates that a usage of the one or more SRSs is associated with the SD-CDD.

In a nineteenth additional aspect, alone or in combination with one or more of the first through eighteenth aspects, the signal includes at least one of one or more SRSs, one or more uplink control channel signals, or one or more uplink data channel signals.

In a twentieth additional aspect, alone or in combination with one or more of the first through nineteenth aspects, the signal includes two or more types of signals, and the SD-CDD value is one of multiple SD-CDD values for respective types of signals of the two or more types of signals.

In a twenty-first additional aspect, alone or in combination with one or more of the first through twentieth aspects, the SD-CDD values for the respective types of signals are a same SD-CDD value.

In a twenty-second additional aspect, alone or in combination with one or more of the first through twenty-first aspects, the SD-CDD values include a first SD-CDD value for a first type of signal and a second SD-CDD value for a second type of signal, and the first SD-CDD value is different than the second SD-CDD value.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a network node or an apparatus of a network node that supports a diversity scheme indication in accordance with the present disclosure. Example process 1100 is an example where the apparatus or the network node (for example, network node 110) performs operations associated with a diversity scheme indication.

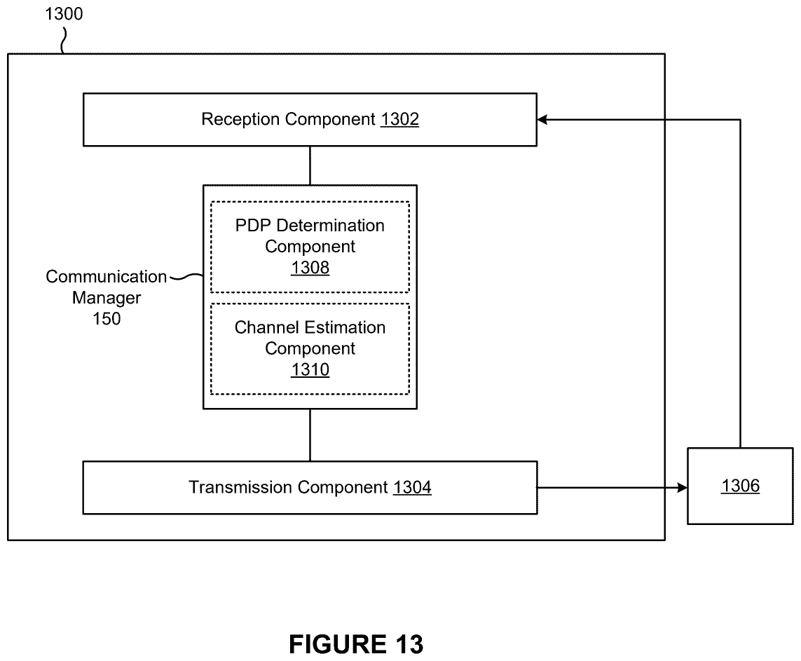

As shown in FIG. 11, in some aspects, process 1100 may include communicating an indication that a SD-CDD is to be applied (block 1110). For example, the network node (such as by using communication manager 150, reception component 1302, or transmission component 1304, depicted in FIG. 13) may communicate an indication that a SD-CDD is to be applied, as described above.

As further shown in FIG. 11, in some aspects, process 1100 may include receiving, in accordance with communicating the indication that the SD-CDD is to be applied, multiple instances of a signal via a channel, channel estimation information of the channel being in accordance with a SD-CDD value associated with the SD-CDD (block 1120). For example, the network node (such as by using communication manager 150 or reception component 1302, depicted in FIG. 13) may receive, in accordance with communicating the indication that the SD-CDD is to be applied, multiple instances of a signal via a channel, channel estimation information of the channel being in accordance with a SD-CDD value associated with the SD-CDD, as described above.

Process 1100 may include additional aspects, such as any single aspect or any combination of aspects described below or in connection with one or more other processes described elsewhere herein.

In a first additional aspect, receiving the multiple instances of the signal includes receiving one or more reference signals in accordance with the SD-CDD value, and process 1100 includes obtaining a PDP profile associated with the one or more reference signals, and performing, using the PDP, a channel estimation operation to obtain the channel estimation information.

In a second additional aspect, alone or in combination with the first aspect, communicating the indication that the SD-CDD is to be applied includes transmitting, to a UE, the indication that the SD-CDD is to be applied.

In a third additional aspect, alone or in combination with one or more of the first and second aspects, transmitting the indication that the SD-CDD is to be applied includes transmitting control signaling including the indication.

In a fourth additional aspect, alone or in combination with one or more of the first through third aspects, transmitting the indication that the SD-CDD is to be applied includes transmitting at least one of a downlink control information message, a MAC-CE message, or an RRC message.

In a fifth additional aspect, alone or in combination with one or more of the first through fourth aspects, transmitting the indication that the SD-CDD is to be applied includes transmitting a downlink control information message including a grant associated with the signal, wherein the downlink control information message includes the indication that the SD-CDD is to be applied.

In a sixth additional aspect, alone or in combination with one or more of the first through fifth aspects, communicating the indication includes communicating a first communication including the indication that the SD-CDD is to be applied, wherein the indication includes an activation command associated with applying the SD-CDD, an process 1100 includes communicating, after communicating the first communication, a second communication including a deactivation command that indicates that the SD-CDD is not to be applied.

In a seventh additional aspect, alone or in combination with one or more of the first through sixth aspects, the activation command is valid until the deactivation command is communicated. In an eighth additional aspect, alone or in combination with one or more of the first through seventh aspects, the deactivation command is valid until a subsequent activation command is communicated. In a ninth additional aspect, alone or in combination with one or more of the first through eighth aspects, communicating the indication that the SD-CDD is to be applied is included in one or more SPS communications. In a tenth additional aspect, alone or in combination with one or more of the first through ninth aspects, communicating the indication that the SD-CDD is to be applied includes receiving the indication that the SD-CDD is to be applied.

In an eleventh additional aspect, alone or in combination with one or more of the first through tenth aspects, receiving the indication that the SD-CDD is to be applied includes receiving control signaling including the indication that the SD-CDD is to be applied. In a twelfth additional aspect, alone or in combination with one or more of the first through eleventh aspects, receiving the indication that the SD-CDD is to be applied includes receiving at least one of a control information message, or a MAC-CE message. In a thirteenth additional aspect, alone or in combination with one or more of the first through twelfth aspects, communicating the indication that the SD-CDD is to be applied includes communicating a first control signaling message including the indication that the SD-CDD is to be applied, wherein the indication is associated with a timer indicative of a time period during which the SD-CDD is to be applied, and process 1100 includes communicating, in accordance with an expiry of the timer, one or more other signals independent of the SD-CDD value.

In a fourteenth additional aspect, alone or in combination with one or more of the first through thirteenth aspects, process 1100 includes receiving an indication of the SD-CDD value. In a fifteenth additional aspect, alone or in combination with one or more of the first through fourteenth aspects, the indication that the SD-CDD is to be applied includes the indication of the SD-CDD value. In a sixteenth additional aspect, alone or in combination with one or more of the first through fifteenth aspects, the indication of the SD-CDD value is included in a MAC-CE.

In a seventeenth additional aspect, alone or in combination with one or more of the first through sixteenth aspects, receiving the multiple instances of the signal includes receiving the multiple instances of the signal independently of one or more SRSs.

In an eighteenth additional aspect, alone or in combination with one or more of the first through seventeenth aspects, receiving the multiple instances of the signal includes receiving multiple copies of an SRS in accordance with the SD-CDD value.

In a nineteenth additional aspect, alone or in combination with one or more of the first through eighteenth aspects, process 1100 includes transmitting control signaling including a configuration for the one or more SRSs, wherein the configuration indicates that a usage of the one or more SRSs is associated with the SD-CDD.

In a twentieth additional aspect, alone or in combination with one or more of the first through nineteenth aspects, the signal includes at least one of one or more of one or more SRSs, one or more uplink control channel signals, or one or more uplink data channel signals.

In a twenty-first additional aspect, alone or in combination with one or more of the first through twentieth aspects, the signal includes two or more types of signals, and the SD-CDD value is one of multiple SD-CDD values for respective types of signals of the two or more types of signals.

In a twenty-second additional aspect, alone or in combination with one or more of the first through twenty-first aspects, the SD-CDD values for the respective types of signals are a same SD-CDD value.

In a twenty-third additional aspect, alone or in combination with one or more of the first through twenty-second aspects, the SD-CDD values include a first SD-CDD value for a first type of signal and a second SD-CDD value for a second type of signal, and the first SD-CDD value is different than the second SD-CDD value.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports a diversity scheme indication in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIGS. 6-7. Additionally or alternatively, the apparatus 1200 may be configured to and/or operable to perform one or more processes described herein, such as process 1000 of FIG. 10. In some aspects, the apparatus 1200 may include one or more components of the UE described above in connection with FIG. 1 and FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, one or more modems, one or more demodulators, one or more MIMO detectors, one or more receive processors, one or more controllers/processors, and/or one or more memories of the UE described above in connection with FIG. 1 and FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, and/or one or more memories of the UE described above in connection with FIG. 1 and FIG. 2. In some aspects, the transmission component 1204 may be co-located with the reception component 1202 in one or more transceivers.

The communication manager 140 may communicate an indication that a SD-CDD is to be applied. The communication manager 140 may identify, in association with communicating the indication that the SD-CDD is to be applied, a SD-CDD value. The communication manager 140 may transmit or may cause the transmission component 1204 to transmit multiple instances of a signal in accordance with the SD-CDD value. In some aspects, the communication manager 140 may perform one or more operations described elsewhere herein as being performed by one or more components of the communication manager 140.

The communication manager 140 may include one or more controllers/processors, and/or one or more memories, of the UE described above in connection with FIG. 1 and FIG. 2. In some aspects, the communication manager 140 includes a set of components, such as an SD-CDD value identification component 1210. Alternatively, the set of components may be separate and distinct from the communication manager 140. In some aspects, one or more components of the set of components may include or may be implemented within one or more controllers/processors, and/or one or more memories of the UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1204, and/or the reception component 1202 may communicate (for example, transmit or receive) an indication that a SD-CDD is to be applied. The SD-CDD value identification component 1210 may identify, in association with communicating the indication that the SD-CDD is to be applied, a SD-CDD value. The transmission component 1204 may transmit multiple instances of a signal in accordance with the SD-CDD value.

The transmission component 1204 may transmit an indication of the SD-CDD value.

The reception component 1202 may receive control signaling including a configuration for the one or more SRSs, wherein the configuration indicates that a usage of the one or more SRSs is associated with the SD-CDD.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports a diversity scheme indication in accordance with the present disclosure. The apparatus 1300 may be a network node, or a network node may include the apparatus 1300. In some aspects, the apparatus 1300 includes a reception component 1302, a transmission component 1304, and a communication manager 150, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to and/or operable to perform one or more operations described herein in connection with FIGS. 6-9. Additionally or alternatively, the apparatus 1300 may be configured to and/or operable to perform one or more processes described herein, such as process 1100 of FIG. 11. In some aspects, the apparatus 1300 may include one or more components of the network node described above in connection with FIG. 1 and FIG. 2.

The reception component 1302 may receive communications, such as reference signals, control information, and/or data communications, from the apparatus 1306. The reception component 1302 may provide received communications to one or more other components of the apparatus 1300, such as the communication manager 150. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, one or more modems, one or more demodulators, one or more MIMO detectors, one or more receive processors, one or more controllers/processors, and/or one or more memories of the network node described above in connection with FIG. 1 and FIG. 2.

The transmission component 1304 may transmit communications, such as reference signals, control information, and/or data communications, to the apparatus 1306. In some aspects, the communication manager 150 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, one or more modems, one or more modulators, one or more transmit MIMO processors, one or more transmit processors, one or more controllers/processors, and/or one or more memories of the network node described above in connection with FIG. 1 and FIG. 2. In some aspects, the transmission component 1304 may be co-located with the reception component 1302 in one or more transceivers.

The communication manager 150 may communicate an indication that a SD-CDD is to be applied. The communication manager 150 may receive or may cause the reception component 1302 to receive, in accordance with communicating the indication that the SD-CDD is to be applied, multiple instances of a signal via a channel, channel estimation information of the channel being in accordance with a SD-CDD value associated with the SD-CDD. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 1 and FIG. 2. In some aspects, the communication manager 150 includes a set of components, such as a PDP determination component 1308, and/or a channel estimation component 1310. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 and/or the transmission component 1304 may communicate an indication that a SD-CDD is to be applied. The reception component 1302 a may receive, in accordance with communicating the indication that the SD-CDD is to be applied, multiple instances of a signal via a channel, channel estimation information of the channel being in accordance with a SD-CDD value associated with the SD-CDD.

The PDP determination component 1308 may obtain a PDP associated with the one or more reference signals. The channel estimation component 1310 may perform, using the PDP, a channel estimation operation to obtain the channel estimation information. The reception component 1302 may receive an indication of the SD-CDD value.

The transmission component 1304 may transmit control signaling including a configuration for the one or more SRSs, wherein the configuration indicates that a usage of the one or more SRSs is associated with the SD-CDD.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication by a user equipment (UE), comprising: communicating an indication that a small delay cyclic delay diversity (CDD) is to be applied; identifying, in association with communicating the indication that the small delay CDD is to be applied, a small delay CDD value; and transmitting multiple instances of a signal in accordance with the small delay CDD value.

Aspect 2: The method of Aspect 1, wherein communicating the indication that the small delay CDD is to be applied comprises: receiving, from a network node, the indication that the small delay CDD is to be applied by the UE.

Aspect 3: The method of Aspect 2, wherein receiving the indication that the small delay CDD is to be applied comprises: receiving control signaling comprising the indication.

Aspect 4: The method of any of Aspects 2-3, wherein receiving the indication that the small delay CDD is to be applied comprises: receiving at least one of a downlink control information message, a medium access control (MAC) control element message, or a radio resource control message.

Aspect 5: The method of any of Aspects 2-3, wherein receiving the indication that the small delay CDD is to be applied comprises: receiving a downlink control information message comprising a grant associated with the signal, wherein the downlink control information message includes the indication that the small delay CDD is to be applied.

Aspect 6: The method of any of Aspects 1-5, wherein communicating the indication that the small delay CDD is to be applied comprises: communicating a first communication comprising the indication that the small delay CDD is to be applied, wherein the indication includes an activation command associated with applying the small delay CDD, the method further comprising: communicating, after communicating the first communication, a second communication comprising a deactivation command that indicates that the small delay CDD is not to be applied.

Aspect 7: The method of Aspect 6, wherein the activation command is valid until the deactivation command is communicated.

Aspect 8: The method of any of Aspects 6-7, wherein the deactivation command is valid until a subsequent activation command is communicated.

Aspect 9: The method of any of Aspects 1-8, wherein communicating the indication that the small delay CDD is to be applied is included in one or more semi-persistent scheduling (SPS) communications.

Aspect 10: The method of any of Aspects 1-9, wherein communicating the indication that the small delay CDD is to be applied comprises: transmitting the indication that the small delay CDD is to be applied.

Aspect 11: The method of Aspect 10, wherein transmitting the indication that the small delay CDD is to be applied comprises: transmitting control signaling comprising the indication that the small delay CDD is to be applied.

Aspect 12: The method of any of Aspects 10-11, wherein transmitting the indication that the small delay CDD is to be applied comprises: transmitting at least one of a control information message, or a medium access control (MAC) control element message.

Aspect 13: The method of any of Aspects 1-12, wherein communicating the indication that the small delay CDD is to be applied comprises: communicating a first communication comprising the indication that the small delay CDD is to be applied, wherein the indication is associated with a timer indicative of a time period during which the small delay CDD is to be applied, the method further comprising: communicating, in accordance with an expiry of the timer, one or more other signals independent of the small delay CDD value.

Aspect 14: The method of any of Aspects 1-13, further comprising: transmitting an indication of the small delay CDD value.

Aspect 15: The method of Aspect 14, wherein the indication that the small delay CDD is to be applied comprises the indication of the small delay CDD value.

Aspect 16: The method of any of Aspects 14-15, wherein the indication of the small delay CDD value is included in a medium access control (MAC) control element.

Aspect 17: The method of any of Aspects 1-16, wherein transmitting the multiple instances of the signal comprises: transmitting the multiple instances of the signal independently of one or more sounding reference signals.

Aspect 18: The method of any of Aspects 1-17, wherein transmitting the multiple instances of the signal comprises: transmitting multiple copies of a sounding reference signal in accordance with the small delay CDD value.

Aspect 19: The method of Aspect 18, further comprising: receiving control signaling comprising a configuration for the one or more sounding reference signals, wherein the configuration indicates that a usage of the one or more sounding reference signals is associated with the small delay CDD.

Aspect 20: The method of any of Aspects 1-19, wherein the signal includes at least one of: one or more sounding reference signals, one or more uplink control channel signals, or one or more uplink data channel signals.

Aspect 21: The method of any of Aspects 1-20, wherein the signal comprises two or more types of signals, and wherein the small delay CDD value is one of multiple small delay CDD values for respective types of signals of the two or more types of signals.

Aspect 22: The method of Aspect 21, wherein the small delay CDD values for the respective types of signals are a same small delay CDD value.

Aspect 23: The method of Aspect 21, wherein the small delay CDD values include a first small delay CDD value for a first type of signal and a second small delay CDD value for a second type of signal, and wherein the first small delay CDD value is different than the second small delay CDD value.

Aspect 24: A method of wireless communication by a network node, comprising: communicating an indication that a small delay cyclic delay diversity (CDD) is to be applied; and receiving, in accordance with communicating the indication that the small delay CDD is to be applied, multiple instances of a signal via a channel, channel estimation information of the channel being in accordance with a small delay CDD value associated with the small delay CDD.

Aspect 25: The method of Aspect 24, wherein receiving the multiple instances of the signal comprises: receiving multiple instances of a reference signal in accordance with the small delay CDD value, the method further comprising: obtaining a power delay profile associated with the reference signal; and performing, using the power delay profile, a channel estimation operation to obtain the channel estimation information.

Aspect 26: The method of any of Aspects 24-25, wherein communicating the indication that the small delay CDD is to be applied comprises: transmitting, to a user equipment (UE), the indication that the small delay CDD is to be applied.

Aspect 27: The method of Aspect 26, wherein transmitting the indication that the small delay CDD is to be applied comprises: transmitting control signaling comprising the indication.

Aspect 28: The method of any of Aspects 26-27, wherein transmitting the indication that the small delay CDD is to be applied comprises: transmitting at least one of a downlink control information message, a medium access control (MAC) control element message, or a radio resource control message.

Aspect 29: The method of any of Aspects 26-27, wherein transmitting the indication that the small delay CDD is to be applied comprises: transmitting a downlink control information message comprising a grant associated with the signal, wherein the downlink control information message includes the indication that the small delay CDD is to be applied.

Aspect 30: The method of any of Aspects 24-29, wherein communicating the indication comprises: communicating a first communication comprising the indication that the small delay CDD is to be applied, wherein the indication includes an activation command associated with applying the small delay CDD, the method further comprising: communicating, after communicating the first communication, a second communication comprising a deactivation command that indicates that the small delay CDD is not to be applied.

Aspect 31: The method of Aspect 30, wherein the activation command is valid until the deactivation command is communicated.

Aspect 32: The method of any of Aspects 30-31, wherein the deactivation command is valid until a subsequent activation command is communicated.

Aspect 33: The method of any of Aspects 24-32, wherein communicating the indication that the small delay CDD is to be applied is included in one or more semi-persistent scheduling (SPS) communications.

Aspect 34: The method of any of Aspects 24-33, wherein communicating the indication that the small delay CDD is to be applied comprises: receiving the indication that the small delay CDD is to be applied.

Aspect 35: The method of Aspect 34, wherein receiving the indication that the small delay CDD is to be applied comprises: receiving control signaling comprising the indication that the small delay CDD is to be applied.

Aspect 36: The method of any of Aspect 34-35, wherein receiving the indication that the small delay CDD is to be applied comprises: receiving at least one of a control information message, or a medium access control (MAC) control element message.

Aspect 37: The method of any of Aspects 24-36, wherein communicating the indication that the small delay CDD is to be applied comprises: communicating a first control signaling message comprising the indication that the small delay CDD is to be applied, wherein the indication is associated with a timer indicative of a time period during which the small delay CDD is to be applied, the method further comprising: communicating, in accordance with an expiry of the timer, one or more other signals independent of the small delay CDD value.

Aspect 38: The method of any of Aspects 24-37, further comprising: receiving an indication of the small delay CDD value.

Aspect 39: The method of Aspect 38, wherein the indication that the small delay CDD is to be applied comprises the indication of the small delay CDD value.

Aspect 40: The method of any of Aspects 38-39, wherein the indication of the small delay CDD value is included in a medium access control (MAC) control element.

Aspect 41: The method of any of Aspects 24-40, wherein receiving the multiple instances of the signal comprises: receiving the multiple instances of the signal independently of one or more sounding reference signals.

Aspect 42: The method of any of Aspects 24-41, wherein receiving the multiple instances of the signal comprises: receiving multiple copies of a sounding reference signal in accordance with the small delay CDD value.

Aspect 43: The method of Aspect 42, further comprising: transmitting control signaling comprising a configuration for the one or more sounding reference signals, wherein the configuration indicates that a usage of the one or more sounding reference signals is associated with the small delay CDD.

Aspect 44: The method of any of Aspects 24-43, wherein the signal comprises one or more of: one or more sounding reference signals, one or more uplink control channel signals, or one or more uplink data channel signals.

Aspect 45: The method of any of Aspects 24-44, wherein the signal comprises two or more types of signals, and wherein the small delay CDD value is one of multiple small delay CDD values for respective types of signals of the two or more types of signals.

Aspect 46: The method of Aspect 45, wherein the small delay CDD values for the respective types of signals are a same small delay CDD value.

Aspect 47: The method of Aspect 45, wherein the small delay CDD values include a first small delay CDD value for a first type of signal and a second small delay CDD value for a second type of signal, and wherein the first small delay CDD value is different than the second small delay CDD value.

Aspect 48: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-47.

Aspect 49: An apparatus for wireless communication at a device, the apparatus comprising one or more memories and one or more processors coupled to the one or more memories, the one or more processors configured to cause the device to perform the method of one or more of Aspects 1-47.

Aspect 50: An apparatus for wireless communication, the apparatus comprising at least one means for performing the method of one or more of Aspects 1-47.

Aspect 51: A non-transitory computer-readable medium storing code for wireless communication, the code comprising instructions executable by one or more processors to perform the method of one or more of Aspects 1-47.

Aspect 52: A non-transitory computer-readable medium storing a set of instructions for wireless communication, the set of instructions comprising one or more instructions that, when executed by one or more processors of a device, cause the device to perform the method of one or more of Aspects 1-47.

Aspect 53: A device for wireless communication, the device comprising a processing system that includes one or more processors and one or more memories coupled with the one or more processors, the processing system configured to cause the device to perform the method of one or more of Aspects 1-47.

Aspect 54: An apparatus for wireless communication at a device, the apparatus comprising one or more memories and one or more processors coupled to the one or more memories, the one or more processors individually or collectively configured to cause the device to perform the method of one or more of Aspects 1-47.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
communicate an indication that a small delay cyclic delay diversity (CDD) is to be applied;
identify, in association with communicating the indication that the small delay CDD is to be applied, a small delay CDD value; and
transmit multiple instances of a signal in accordance with the small delay CDD value.

2. The UE of claim 1, wherein, to cause the UE to communicate the indication that the small delay CDD is to be applied, the processing system is configured to cause the UE to:
receive, from a network node, the indication that the small delay CDD is to be applied by the UE.

3. The UE of claim 2, wherein, to cause the UE to receive the indication that the small delay CDD is to be applied, the processing system is configured to cause the UE to:
receive control signaling comprising the indication.

4. The UE of claim 2, wherein, to cause the UE to receive the indication that the small delay CDD is to be applied, the processing system is configured to cause the UE to:
receive at least one of a downlink control information message, a medium access control (MAC) control element message, or a radio resource control message.

5. The UE of claim 2, wherein, to cause the UE to receive the indication that the small delay CDD is to be applied, the processing system is configured to cause the UE to:
receive a downlink control information message comprising a grant associated with the signal, wherein the downlink control information message includes the indication that the small delay CDD is to be applied.

6. The UE of claim 1, wherein, to cause the UE to communicate the indication that the small delay CDD is to be applied, the processing system is configured to cause the UE to:
communicate a first communication comprising the indication that the small delay CDD is to be applied, wherein the indication includes an activation command associated with applying the small delay CDD, wherein the processing system is further configured to cause the UE to:
communicate, after communicating the first communication, a second communication comprising a deactivation command that indicates that the small delay CDD is not to be applied.

7. The UE of claim 1, wherein communicating the indication that the small delay CDD is to be applied is included in one or more semi-persistent scheduling (SPS) communications.

8. The UE of claim 1, wherein, to cause the UE to communicate the indication that the small delay CDD is to be applied, the processing system is configured to cause the UE to:
communicate a first communication comprising the indication that the small delay CDD is to be applied, wherein the indication is associated with a timer indicative of a time period during which the small delay CDD is to be applied, and wherein the processing system is further configured to cause the UE to:
communicate, in accordance with an expiry of the timer, one or more other signals independent of the small delay CDD value.

9. The UE of claim 1, wherein the processing system is further configured to cause the UE to:
transmit an indication of the small delay CDD value.

10. The UE of claim 1, wherein, to cause the UE to transmit the multiple instances of the signal, the processing system is configured to cause the UE to:
transmit the multiple instances of the signal independently of one or more sounding reference signals.

11. The UE of claim 1, wherein, to cause the UE to transmit the multiple instances of the signal, the processing system is configured to cause the UE to:
transmit multiple copies of a sounding reference signal in accordance with the small delay CDD value.

12. The UE of claim 1, wherein the signal comprises two or more types of signals, and wherein the small delay CDD value is one of multiple small delay CDD values for respective types of signals of the two or more types of signals.

13. A network node for wireless communication, comprising:
a processing system that includes one or more processors and one or more memories coupled with the one or more processors, the processing system configured to cause the network node to:
communicate an indication that a small delay cyclic delay diversity (CDD) is to be applied; and
receive, in accordance with communicating the indication that the small delay CDD is to be applied, multiple instances of a signal via a channel, channel estimation information of the channel being in accordance with a small delay CDD value associated with the small delay CDD.

14. The network node of claim 13, wherein, to cause the network node to receive the multiple instances of the signal, the processing system is configured to cause the network node to:
receive multiple instances of a reference signal in accordance with the small delay CDD value, wherein the processing system is further configured to cause the network node to:
obtain a power delay profile associated with the reference signal; and
perform, using the power delay profile, a channel estimation operation to obtain the channel estimation information.

15. The network node of claim 13, wherein, to cause the network node to communicate the indication, the processing system is configured to cause the network node to:
communicate a first communication comprising the indication that the small delay CDD is to be applied, wherein the indication includes an activation command associated with applying the small delay CDD, and wherein the processing system is further configured to cause the network node to:
communicate, after communicating the first communication, a second communication comprising a deactivation command that indicates that the small delay CDD is not to be applied.

16. The network node of claim 13, wherein communicating the indication that the small delay CDD is to be applied is included in one or more semi-persistent scheduling (SPS) communications.

17. The network node of claim 13, wherein, to cause the network node to communicate the indication that the small delay CDD is to be applied, the processing system is configured to cause the network node to:
receive the indication that the small delay CDD is to be applied.

18. The network node of claim 13, wherein, to cause the network node to communicate the indication that the small delay CDD is to be applied, the processing system is configured to cause the network node to:
communicate a first control signaling message comprising the indication that the small delay CDD is to be applied, wherein the indication is associated with a timer indicative of a time period during which the small delay CDD is to be applied, wherein the processing system is further configured to cause the network node to:
communicate, in accordance with an expiry of the timer, one or more other signals independent of the small delay CDD value.

19. The network node of claim 13, wherein the processing system is further configured to cause the network node to:
receive an indication of the small delay CDD value.

20. The network node of claim 13, wherein, to cause the network node to receive the multiple instances of the signal, the processing system is configured to cause the network node to:
receive the multiple instances of the signal independently of one or more sounding reference signals.

21. The network node of claim 13, wherein, to cause the network node to receive the multiple instances of the signal, the processing system is configured to cause the network node to:
receive multiple copies of a sounding reference signal in accordance with the small delay CDD value.

22. The network node of claim 13, wherein the signal comprises two or more types of signals, and wherein the small delay CDD value is one of multiple small delay CDD values for respective types of signals of the two or more types of signals.

23. A method of wireless communication by a user equipment (UE), comprising:
communicating an indication that a small delay cyclic delay diversity (CDD) is to be applied;
identifying, in association with communicating the indication that the small delay CDD is to be applied, a small delay CDD value; and
transmitting multiple instances of a signal in accordance with the small delay CDD value.

24. The method of claim 23, wherein communicating the indication that the small delay CDD is to be applied comprises:
transmitting the indication that the small delay CDD is to be applied.

25. The method of claim 24, wherein transmitting the indication that the small delay CDD is to be applied comprises:
transmitting control signaling comprising the indication that the small delay CDD is to be applied.

26. The method of claim 24, wherein transmitting the indication that the small delay CDD is to be applied comprises:
transmitting at least one of a control information message, or a medium access control (MAC) control element message.

27. A method of wireless communication by a network node, comprising:
communicating an indication that a small delay cyclic delay diversity (CDD) is to be applied; and
receiving, in accordance with communicating the indication that the small delay CDD is to be applied, multiple instances of a signal via a channel, channel estimation information of the channel being in accordance with a small delay CDD value associated with the small delay CDD.

28. The method of claim 27, wherein communicating the indication that the small delay CDD is to be applied comprises:
transmitting, to a user equipment (UE), the indication that the small delay CDD is to be applied.

29. The method of claim 28, wherein transmitting the indication that the small delay CDD is to be applied comprises:
transmitting control signaling comprising the indication.

30. The method of claim 28, wherein transmitting the indication that the small delay CDD is to be applied comprises:
transmitting a downlink control information message comprising a grant associated with the signal, wherein the downlink control information message includes the indication that the small delay CDD is to be applied.
